(19) United States
(12) Patent Application Publication
(10) Pub. No.: US 2026/0143335 A1
(43) Pub. Date: May 21, 2026

(54) SYSTEMS AND METHODS FOR ONBOARDING A WIRELESS NETWORK EXTENDER

(71) Applicant: CABLE TELEVISION LABORATORIES, INC., Louisville, CO (US)

(72) Inventors: DARSHAK THAKORE, Vestavia Hills, AL (US); CRAIG M. PRATT, Portland, OR (US); JOHN C. BAHR, Superior, CO (US)

(21) Appl. No.: 19/444,785

(22) Filed: Jan. 9, 2026

Related U.S. Application Data
(62) Division of application No. 18/130,377, filed on Apr. 3, 2023.
Application No. 18/130,377 is a continuation-in-part of application No. 17/592,317, filed on Feb. 3, 2022, now Pat. No. 12,238,517.
(60) Provisional application No. 63/145,165, filed on Feb. 3, 2021.
(60) Provisional application No. 63/240,498, filed on Sep. 3, 2021.
(60) Provisional application No. 63/326,665, filed on Apr. 1, 2022.
(60) Provisional application No. 63/326,685, filed on Apr. 1, 2022.

(51) Int. Cl. H04W 8/26; H04L 9/32; H04W 12/08; H04W 84/18

(52) U.S. Cl. CPC H04W 8/26; H04L 9/32; H04W 12/08; H04W 84/18

(57) ABSTRACT

A method for onboarding a wireless network extender in a wireless mesh network includes (a) transferring each of a first passphrase and a first service set identifier (SSID) to the wireless network extender, (b) adding the first passphrase to a list of allowed passphrases at a first access point of the wireless mesh network, and (c) at the first access point, accepting a connection from the wireless network extender on a wireless network identified by a second SSID. A method operable by an application of a user device for dynamic activation of communication service includes (a) receiving a voucher credential, (b) cooperating with communication infrastructure to verify the voucher credential, (c) receiving, from a user, a service plan selection, and (d) cooperating with the communication infrastructure to activate the service plan.

### CROSS REFERENCE TO RELATED APPLICATIONS

This application is a divisional application of U.S. patent application Ser. No. 18/130,377, filed Apr. 3, 2023, which application is a continuation in part of U.S. patent application Ser. No. 17/592,317, filed on Feb. 3, 2022, which claims the benefit of and priority to U.S. Provisional Patent Application No. 63/240,498, filed Sep. 3, 2021, and to U.S. Provisional Patent Application No. 63/145,165, filed Feb. 3, 2021. U.S. patent application Ser. No. 18/130,377 also claims benefit of and priority to each of U.S. Provisional Patent Application No. 63/326,665, filed on Apr. 1, 2022, and U.S. Provisional Patent Application No. 63/326,685, filed on Apr. 1, 2022. Each of the aforementioned patent applications is hereby incorporated by reference in its entirety.

### BACKGROUND

The field of the invention relates generally to managing computer networks, and more specifically, to systems and methods for on-boarding new devices and managing resource allocation for devices on the network.

Traditionally, network services have been set-up to allocate resources and provide connection to devices to the Internet Protocol (IP) address associated with the device. However, there are certain underserved/unserved markets where a traditional product deployment model does not suit or scale. The issues range from the limits on average revenue per user (ARPU) to constraints and physical considerations for being able to deliver service to each customer. The market segment classified as Class C & D deployments are for residences that have multi-dwelling unit-style, or a single-unit cluster layout and the goal is to be able to deliver a viable internet service without requiring a customer premises equipment (CPE) for each subscriber. Furthermore, in many areas, the infrastructure may not be capable of supporting running fiber or optical cables to every dwelling. In addition, most devices connect to networks via Wi-Fi as devices with cellular connections can be expensive.

In some situations, different devices connected through the same access point (AP) may require or support different connection attributes. Accordingly, it would be useful for different devices to be able to connect to the same AP using different connection attributes based on subscriptions or other account management features associated with the device.

### BRIEF DESCRIPTION

In a first aspect, a system for micro-segmented networking is provided. The system includes a system controller including at least one processor in communication with at least one memory device. The system controller is in communication with a wireless network. The system controller is programmed to store a plurality of micro-segmented network accounts and a plurality of subscriber accounts. Each subscriber account of the plurality of subscriber accounts is associated with a micro-segmented network of the plurality of micro-segmented network accounts. The system controller is also programmed to receive a request from a user device to activate a first micro-segmented network associated with a first subscriber account. The request includes subscriber information associated with the first subscriber account. The system controller is further programmed to authenticate the first subscriber account based on the subscriber information. In addition, the system controller is programmed to activate the first micro-segmented network, including a plurality of device slots for a plurality of devices. Moreover, the system controller is programmed to transmit, to the user device, first device slot authentication information for a first device slot of the plurality of device slots. Furthermore, the system controller is programmed to receive, from a first device connecting to the wireless network, the first device slot authentication information. Additionally, the system controller is programmed to authenticate the first device slot authentication information. In response to authenticating the first device slot authentication information, the system controller is programmed to connect the first device to the first micro-segmented network.

In a second aspect, a method for micro-segmented networking is provided. The method is implemented by a computer device comprising at least one processor in communication with at least one memory device. The computer device is in communication with a wireless network. The method includes storing a plurality of micro-segmented network accounts and a plurality of subscriber accounts. Each subscriber account of the plurality of subscriber accounts is associated with a micro-segmented network of the plurality of micro-segmented network accounts. The method also includes receiving a request from a user device to activate a first micro-segmented network associated with a first subscriber account. The request includes subscriber information associated with the first subscriber account. The method further includes authenticating the first subscriber account based on the subscriber information. In addition, the method includes activating the first micro-segmented network, including a plurality of device slots for a plurality of devices. Moreover, the method includes transmitting, to the user device, first device slot authentication information for a first device slot of the plurality of device slots. Furthermore, the method includes receiving, from a first device connecting to the wireless network, the first device slot authentication information. Additionally, the method includes authenticating the first device slot authentication information. In response to authenticating the first device slot authentication information, the method includes connecting the first device to the first micro-segmented network.

In a third aspect, a method for supporting wireless devices in a wireless mesh network includes (a) at a first access point, supporting a first wireless client device using a first service set identifier (SSID), and (b) at the first access point, supporting a wireless network extender using the first SSID.

In an embodiment of the third aspect, the method further includes at the first access point, treating data associated with the first wireless client device differently from data associated with the wireless network extender.

In another embodiment of the third aspect, the method further includes at the first access point, treating data associated with the wireless network extender at least partially based on information obtained during onboarding of the wireless network extender to the wireless mesh network.

In another embodiment of the third aspect, the wireless network extender is configured to relay data between a second wireless client device and the access point.

In another embodiment of the third aspect, the first wireless client device is selected from the group consisting of a mobile phone, a computer, a personal digital assistant (PDA), and an Internet of Things (IoT) device.

In another embodiment of the third aspect, the method further includes at the wireless network extender, supporting a second wireless client device using a second SSID that is different from the first SSID.

In another embodiment of the third aspect, the wireless network extender includes a Wi-Fi extender.

In a fourth aspect, a method for onboarding a wireless network extender in a wireless mesh network includes (a) transferring each of a first passphrase and a first service set identifier (SSID) to the wireless network extender, (b) adding the first passphrase to a list of allowed passphrases at a first access point of the wireless mesh network, and (c) at the first access point, accepting a connection from the wireless network extender on a wireless network identified by a second SSID.

In an embodiment of the fourth aspect, transferring each of the first passphrase and the first SSID to the wireless network extender comprises transferring the first passphrase and the first SSID to the wireless network extender directly via the first access point.

In another embodiment of the fourth aspect, transferring each of the first passphrase and the first SSID to the wireless network extender comprises transferring the first passphrase and the first SSID to the wireless network extender via a user device connected to an access point of the wireless mesh network.

In another embodiment of the fourth aspect, the method further includes, before adding the first passphrase to the list of allowed passphrases at the first access point, receiving an extender Device Object at the first access point, the extender Device object including the first SSID and the first passphrase.

In another embodiment of the fourth aspect, the method further includes performing a lookup of the first passphrase.

In another embodiment of the fourth aspect, the method further includes, at the first access point, providing an Internet Protocol (IP) address to the wireless network extender.

In another embodiment of the fourth aspect, the method further includes providing a universally unique identifier (uuid) to the wireless network extender, the uuid representing a first Service associated with the wireless network extender.

In another embodiment of the fourth aspect, the method further includes providing to the wireless network extender respective passphrases and media access control (MAC) addresses of devices of the first Service.

In another embodiment of the fourth aspect, the wireless network extender includes a Wi-Fi extender.

In a fifth aspect, method operable by an application of a user device for dynamic activation of communication service includes (a) receiving a voucher credential, (b) cooperating with communication infrastructure to verify the voucher credential, (c) receiving, from a user, a service plan selection, and (d) cooperating with the communication infrastructure to activate the service plan.

In an embodiment of the fifth aspect, the method further includes (a) receiving a request from the user to add a new device, (b) cooperating with the communication infrastructure to execute device activation flow, and (c) presenting to the user (1) a service set identifier (SSID) representing a network for serving the new device and (2) a passphrase that is unique to the new device.

In another embodiment of the fifth aspect, the method further includes (a) receiving from the user a request to suspend communication service and (b) cooperating with the communication infrastructure to suspend communication service for the user.

In another embodiment of the fifth aspect, the method further includes (a) receiving from the user a request to resume communication service and (b) cooperating with the communication infrastructure to resume communication service for the user.

### BRIEF DESCRIPTION OF THE DRAWINGS

These and other features, aspects, and advantages of the present disclosure will become better understood when the following detailed description is read with reference to the following accompanying drawings, in which like characters represent like parts throughout the drawings.

FIG. 1 illustrates a first computer network configured for adding and managing devices in accordance with at least one embodiment.

FIG. 2 illustrates a timing diagram of a process for activating a subscriber account for the mesh network shown in FIG. 1.

FIG. 3 illustrates a timing diagram of a process for adding a device to the subscriber account the mesh network shown in FIG. 1.

FIG. 4 is a schematic illustration depicting an exemplary micronetwork architecture, in an embodiment.

FIG. 5 is a schematic illustration depicting an exemplary functional diagram for a Netreach deployment utilizing a micronetwork configuration, in an embodiment.

FIG. 6 is a schematic illustration depicting an exemplary trust domain configuration utilizing a host access point and an OpenVSwitch, in an embodiment.

FIG. 7 illustrates an alternate embodiment of the FIG. 1 computer network further including a wireless network extender awaiting onboarding.

FIG. 8 is a block diagram of one possible embodiment of the FIG. 7 wireless network extender.

FIG. 9 is a flow chart of a method for onboarding the FIG. 7 wireless network extender, according to an embodiment.

FIG. 10 is a timing diagram illustrating a method for configuring credentials of the FIG. 7 wireless network extender using a Device Provisioning Protocol (DPP), according to an embodiment.

FIG. 11 is a timing diagram illustrating a method for configuring credentials of the FIG. 7 wireless network extender using Bluetooth wireless communication, according to an embodiment.

FIG. 12 is a timing diagram illustrating a method for configuring credentials of the FIG. 7 wireless network extender using neither Bluetooth nor DPP, according to an embodiment.

FIG. 13 is a timing diagram illustrating a method for setting up the FIG. 7 wireless network extender after the wireless network extender has received its credentials, according to an embodiment.

FIGS. 14A-14C are collectively a timing diagram illustrating a method for initializing the FIG. 7 wireless network extender, according to an embodiment.

FIGS. 15A-15C are collectively a timing diagram illustrating a method for onboarding a device onto the FIG. 7 wireless network extender, according to an embodiment.

FIG. 16 illustrates an example of the FIG. 7 computer network after onboarding of the wireless network.

FIG. 17 is a timing diagram illustrating a method for user plan activation, according to an embodiment.

FIG. 18 is a timing diagram illustrating a method for adding a new user device, according to an embodiment.

FIG. 19 is a timing diagram illustrating a method for suspending communication service and subsequently resuming communication service, according to an embodiment.

FIG. 20 is a block diagram of a NetReach architecture configured to leverage existing operations support systems and business support systems, according to an embodiment.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The present embodiments are described below with respect to several components of a conventional cable and/or wireless/Wi-Fi networks. Optical networks though, are also contemplated within the scope of the present embodiments. Such optical networks may include, without limitation, an Optical Network Terminal (ONT) or Optical Line Termination (OLT), and an Optical Network Unit (ONU), and may utilize optical protocols such as EPON, RFOG, or GPON. Other types of communication systems are further contemplated, including communication systems capable of x-hauling traffic, satellite operator communication systems, MIMO communication systems, microwave communication systems, short and long haul coherent optic systems, etc. X-hauling is defined herein as any one of or a combination of front-hauling, backhauling, and mid-hauling.

In these additional embodiments, the MTS may include, without limitation, a termination unit such as an ONT, an OLT, a Network Termination Unit, a Satellite Termination Unit, a Cable MTS (CMTS), or other termination systems collectively referred to herein as “Modem Termination Systems (MTS)”. Similarly, the modem described above may include, without limitation, a cable modem (CM), a satellite modem, an Optical Network Unit (ONU), a DSL unit, etc., which are collectively referred to herein as “modems.” Furthermore, the DOCSIS protocol may be substituted with, or further include protocols such as EPON, RFOG, GPON, Satellite Internet Protocol, without departing from the scope of the embodiments herein.

The present embodiments relate generally to managing computer networks, and more specifically, to systems and methods for on-boarding new devices and managing resource allocation for devices on the network. For ease of explanation, the following description may generically refer to these several innovative embodiments as “the NetReach system.” The NetReach system herein enables the user, consumer, and/or customer to easily add devices to a customized, private computer network to ensure that the features of the devices are properly used by the network. In particular, the present embodiments may include one or more of a device to be connected to the network, a device already connected to the network, a gateway, an access point (AP), and/or controller, and a set of network messages.

In one example of use, an individual in an area of use for the NetReach system can use the following steps to gain network access. First, the individual buys a use card. The card includes a code that allows for network access for a period of time for a specific number of devices. The individual then accesses an existing Wi-Fi network. This can be a mesh network associated with the NetReach system or another Wi-Fi network. The individual uses the Wi-Fi network to access a portal for the NetReach system. The address of the portal can be provided on the purchased use card. The individual gets the code from the card. In some embodiments, the code is protected being behind a scratch-off portion of the use card. The individual enters the code into the portal. The portal then provisions for specific number of devices to access the network using a specially created private network. The individual can then load the NetReach application onto their device. The portal and/or a NetReach server provide access information for the specific number of devices. The access information can include an SSID and password for each device. When a device connects to the Wi-Fi using the provided SSID and password, the device is provided with a software defined network (SDN) and/or a virtual private network for access.

In the present NetReach system, a series of micro-segmented networks are used to connect devices to a network and provide network connectivity. In the NetReach system, each micro-segmented network is associated with a subscriber. The micro-segmented network contains multiple connected devices, where the devices are visible to each other on the micro-segmented network and devices on other micro-segmented networks are not visible. Furthermore, the micro-segmented networks are access point agnostic, wherein a first device on the micro-segmented network may be connected through a first access point and a second device on the same micro-segmented network is connected through a second access point. In this system, the capabilities of the micro-segmented network and the devices on the micro-segmented network are set by one or more subscriber attributes. Subscriber attributes can include, but are not limited to, quality of service (QoS), bandwidth, data caps, up/down, operations support systems (OSS) attributes, business support systems attributes, and security models. The subscription and the micro-segmented networks are configured by a NetReach system controller.

The NetReach architecture described herein can provide internet service to subscribers in the form of a Wi-Fi subscription to a set of subscriber-owned devices. The Wi-Fi network around the subscriber's service area is hosted through a mesh of NetReach Access Points (AP's) that are shared across subscribers. One unique feature of the NetReach architecture is that the NetReach AP's host SSID's (Service Set IDentifier) are shared across subscribers, however the micro-segmentation capabilities within the NetReach AP's ensure that the traffic of each subscriber's device-set is isolated from each other. Each device connecting to the network is first authenticated with a device/subscriber-specific credential and upon successful authentication, it is added to the subscriber's micro-segmented network as long as it conforms to the business rules associated with the subscriber's rate plan.

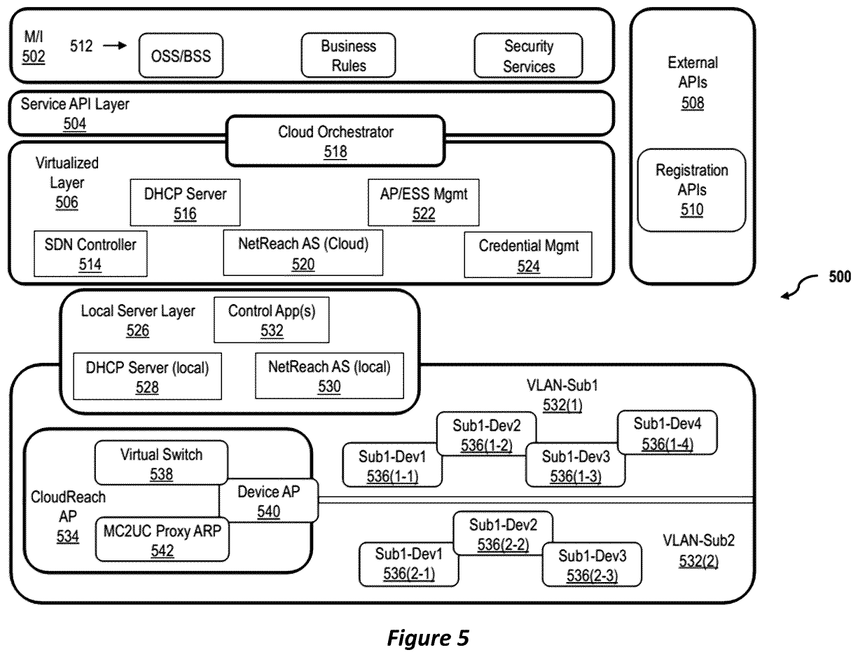

In the NetReach architecture, each NetReach AP incorporates the multiple capabilities. First the AP's form a mesh and operate in a mesh architecture and have a persistent management channel with a cloud orchestrator or controller. Furthermore, each SSID is part of an extended service set (ESS) that is setup and managed from the cloud. In addition, an AP can be part of more than one ESS simultaneously. Moreover, each AP incorporates an SDN (Software-Defined Networking) logical switch to which the Wi-Fi layer access point is bridged to. The AP can support dhcp-relay with support for DHCP Option 82 along with Subscriber-Id sub-option 6 (RFC3993). The AP can also support multicast-to-unicast mode of transmission and Proxy ARP (Address Resolution Protocol). The Wi-Fi module on the AP can support 802.1Q VLAN tagging and Wi-Fi Multimedia (WMM). This NetReach architecture is described in greater detail below with respect to FIG. 5.

When a subscriber first registers for service (likely through an app on a mobile device), the subscriber will be assigned to a specific ESS that is operational in the subscriber's service area. There is a many-to-one relation between an ESS and subscriber, i.e., an ESS may serve multiple subscribers, however a given subscriber can only receive service from a single ESS. If the subscriber moves outside the range of the ESS, they will not be able to receive their service (this is similar to a user moving away from their own Wi-Fi network in their home). Upon initial registration of the subscriber, a unique VLAN will be assigned to that subscriber within that ESS (via all AP's that serve that ESS) and any device that the subscriber connects will be put into that VLAN. When a subscriber wants to connect a new device, they request a new credential/password for the new device through their app and then manually enter the password on that new device.

When a device attempts to associate to the Wi-Fi network, the device uses the provisioned password to authenticate to the network. The AP delegates the initial part of the authentication to the NetReach Authentication Service (NR-AS), which can be hosted on a NetReach server and/or a system controller, and which determines the password used by the device and resolves that to the specific subscriber. The NR-AS notifies the gateway of the mesh network which in turn updates the relevant AP's and pushes the appropriate configuration (DHCP lease info, VLAN assignment, temporal MAC association, SDN flow rules) to the AP's.

Each subscriber and their devices are identified by a subscriber specific VLAN and IP subnet. This allows the NetReach system to assign specific bandwidth and priority rules to the VLAN or groups of VLAN based on the subscription of the subscriber.

Additionally, the WMM feature can be used to provide different levels of service based on the subscriber. The WFA WMM specification defines four access categories (Background, Best Effort, Video, Voice). However, WMM does not specify or guarantee any throughput associated with the access categories. The AP determines how it treats traffic in each access category. The NetReach system sets appropriate CWmin and CWmax values for each access category and can create a mapping between access category and subscription access. This can allow the NetReach system to provide different levels of access, such as based on subscription type. For example, with two levels of subscription tiers-free, paid, the following mapping can be created:

TABLE 1

| | |
|---|---|
| Background | Free tier |
| Best Effort | Reserved |
| Video | Paid tier |
| Voice | Reserved |

This ensures that traffic for all VLAN's that are associated with a free tier subscription is treated with Background characteristics while traffic for VLAN's associated with a paid tier subscription is prioritized compared to the free tier. Note that this classification will only apply to downstream traffic from the AP to the device. There is no assumption or expectation that a device support WMM or that it even uses any WMM access categories. Even if a device specifies a specific WMM access category, the request may be stripped out by the AP and replaced with the appropriate access category based on the subscription tier of the device prior to further processing of the packet. This one-way prioritization is sufficient to create separate traffic-queues based on the subscription tiers. Furthermore, the additional access categories can be used to create additional subscription tiers as necessary.

In the first example, the subscriber gains access to a subscription through one of a plurality of different methods. In the first method, the subscriber purchases an access card that include an access code. In this method, the code may be hidden beneath a scratch-off portion. In the exemplary embodiment, the code provides network access for a period of time. In this method, the code/card could be purchased from a store. The subscriber can then submit the code as described herein. In some embodiments, the code is provided alphanumerically and/or in a scannable bar code or QR code. In the second method, the subscriber is able to pay online, such as through the online portal. In a third method, the subscriber is able to pay a monthly fee for access, such as by automatic billing to a bank account and/or a payment card.

The subscriber is able to connect to the NetReach portal, such as via a mobile computing device. The NetReach portal allows the user to set-up their subscription, such as by entering the card provided access code. The NetReach portal sets-up the subscriber's account and allows the subscriber to add network capable devices to the account. The account has access for a finite number of devices and the subscriber can pick which devices that they wish to add. Devices can include, but are not limited to, smart phones, tablets, laptop computers, smart TVs, Internet of Things (IoT) devices, and/or any other computer devices capable of interacting with the network as described herein.

In a further example, the subscription can have additional attributes, such as, but not limited to, quality of service (QoS), bandwidth, data caps, up/down, operations support systems (OSS) attributes, business support systems attributes, and security models. For example, an employer allows employees to work from home with work-provided computers and phones. The employer can also use the NetReach system to provide improved access to the employee, but only for their work-provided devices. While the employee may have their own router and corresponding home network, the work-provided devices are connected to the work-provided NetReach network. The work-provided devices are put in their own micro-segmented network and are not visible to the other devices in the employee's home or on the employee's home network. In addition, the work-provided network may limit the device's access to different web locations. For example, the work-provided network may only allow access to the work servers and not access to entertainment web-sites. In some embodiments, the NetReach network can control the DNS access for the devices on the network. Furthermore, the bandwidth, QoS, and other attributes of the work-provided network can be different than those of the home network, even though the devices of both networks are connecting through the same router/access point. In addition, the employer could pay for the subscription to provide the work-provided network.

In another example, fifteen students are sharing a dorm with Wi-Fi access through an access point. One of those students is working an internship at a company. The company wants the student to have better reception. The company pays for the student to get 25 down/10 up access through a NetReach network. The student, when using that network, gets that level of access, while the other students connecting to that access point have to compete for the rest of the Wi-Fi capability.

In a further example, a medical Internet of Things (IoT) device could be connected via a NetReach network. The NetReach network provides the device with network access to report any issues and/or report in on how the patient is doing. This secures the medical IoT device on its own network, and makes sure that it can communicate via the network without having to connect to the patient's home network. This allows the subscription for access to be paid for by a third party, such as the insurance, rather than the individual patient.

In an exemplary embodiment, the NetReach management device is the gateway of the network. In other embodiments, the NetReach management device is a part of the access network, such as by a modem termination system (MTS). In these configurations, the NetReach management device may manage all messages from and to the outside networks. In some embodiments, the NetReach management device is outside of the network. This NetReach management device may then provide information to the gateway and/or APs to allow them to connect to subscribed devices and provide network access based on their corresponding subscriptions.

The systems and methods described herein are not limited by the networking protocol used and can be applied to a plurality of network systems and types. These systems and types can include, but are not limited to, cable, 3GPPS 5G technology, optical networks, Low Earth Orbit (LEO) networks, ethernet based networks, IEEE systems (e.g., 802.11 and 16), 5G/MIMO (multiple input multiple output) (OFDM (orthogonal frequency-division multiplexing), BDMA), 4G LTE, 4G (CDMA) WiMAX, 3G HSPA+/UMTS (WCDMA/CDMA), 2G/GSM (TDMA/CDMA), Wi-Fi (all), Optical (PON/CPON/etc.), Ethernet (all: 10Base2, 10Base5, 10BaseT, 100BaseTX, 100Base FX, 1000Base SX, 1000Base LX, etc.), DSL, and RAN, for non-limiting examples.

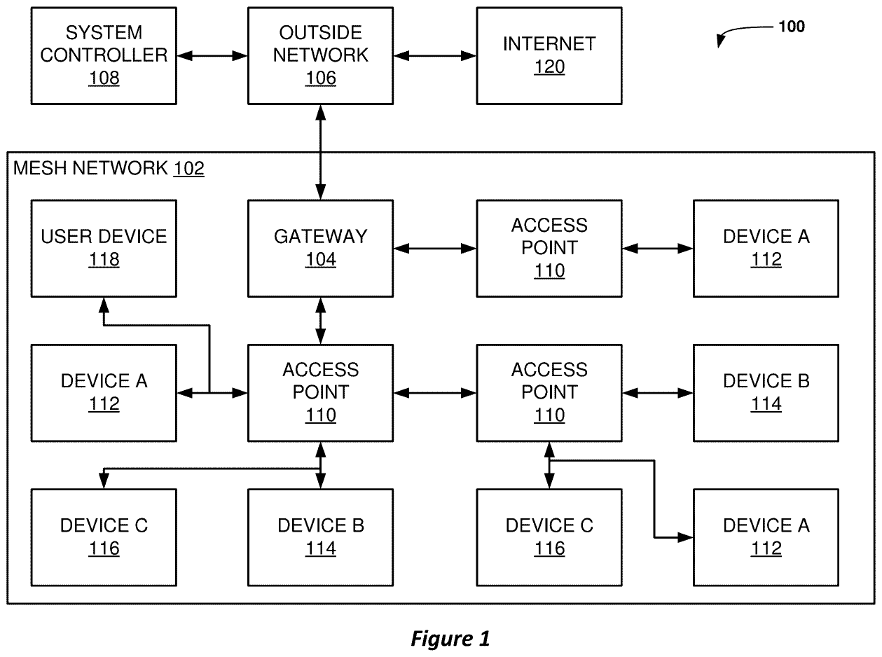

FIG. 1 illustrates a NetReach architecture 100 configured for adding and managing devices in accordance with at least one embodiment. In an exemplary embodiment, NetReach architecture 100 includes a mesh network 102. In this example, mesh network 102 is depicted, by way of example and not in a limiting sense, a local area network (LAN) and includes a gateway 104 with access to one or more outside networks 106. Outside networks 106 may include, but are not limited to, the Internet, another LAN, an access network, and a wide area network (WAN). One of the advantages of the NetReach architecture 100 as described herein is that the systems and methods described herein can provide additional services with existing architecture.

Mesh network 102 includes a plurality of access points 110. Access points 110 connect to various devices, including device A 112, device B 114, device C 116, and user device 118 to mesh network 102. Access point 110 allows device A 112, device B 114, device C 116, and/or user device 118 to connect using wired and/or wireless connections. In the exemplary embodiment, the plurality of access points 110 cover an area, such as a residential area, to provide Wi-Fi access to individuals in the area of coverage. When a device is attached to the mesh network 102 via Wi-Fi, the devices messages are routed from one AP 110 to another AP 110 in the mesh network 102 until the messages reach a gateway 104 with access to outside networks 106, such as through a fiber backend.

In some embodiments, gateway 104 is also an access point 110. In other embodiments, the access points 110 are separate from gateway 104. The mesh network 102 includes multiple access points 110. Access points 110 can include, but are not limited to, a Wi-Fi router, a Wi-Fi extender, a hub, a router, a switch, and/or any other network device that allows devices to connect to the mesh network 102. In some embodiments, a plurality of access points 110 are provided around a neighborhood to provide Wi-Fi access to the neighborhood, where the plurality of access points 110 are not associated with any specific dwelling or family. In at least one embodiment, the plurality of access points 110 are attached to power poles or other utility poles.

Access points 110 can include a WAP (Wireless Application Protocol) module and incorporate the Wi-Fi hardware and the associated AP software, such as host APD (access point daemon). The Wi-Fi chipset and software could include Wi-Fi 5 or higher with support for 802.1Q tagging, WMM (Wi-Fi Multimedia), multicast-to-unicast conversion, and support a minimum of 8 virtual SSID's. To ensure that traffic for each multi-segmented network is enforced, the AP 110 can include one or more virtual switches. The virtual switches are software defined switches, such as OpenVSwitch, to which the Access Point 110 bridges each device that connects to it. A virtual port interface is created for each device that connects to the AP 110 and the traffic is managed by the rules enforced in the virtual switch.

Devices A 112, B 114, and C 116 may include, but are not limited to, IoT devices, such as, but not limited to, IP cameras, smart home devices, smart televisions, smart speakers, and/or medical IoT devices, user computing devices, such as, but not limited to, smart phones, tablets, a personal digital assistant (PDA), and/or laptop computers, and/or any other computer devices capable of interacting with mesh network 102 as described herein. User devices 118 may include, but are not limited to, smart phones, tablets, laptop computers, a personal digital assistant (PDA), and/or any other computer devices capable of interacting with mesh network 102 as described herein. User devices 118 may connect to access point 110 by wired and/or wireless connections, based on the user device 118 itself. Some user devices 118 may be associated with the mesh network 102 and are connected to the mesh network 102 on a regular basis. Other user devices 118 may connect to mesh network 102 occasionally.

In at least one embodiment, a system controller 108 controls a plurality of micro-segmented networks associated with a plurality of subscribers. All device A's 112 are a part of a first micro-segmented network associated with subscriber A. Device B's 114 are a part of a second micro-segmented network associated with subscriber B. Device C's 116 are a part of a third micro-segmented network associated with subscriber C. User device 118 represents a device that is not currently associated with any micro-segmented network. Each micro-segmented network allows the devices on that network to see each other and to communicate with the outside network 106 and potentially the Internet 120. The system controller 108 is the component responsible for resolving the password used by a device while it is associating and authenticating with the network and determine the device eligibility, subscriber information, and subscription tier. The system controller 108 can be implemented as a distributed service with a local component to speed up the authentication.

Each micro-segmented network contains multiple connected devices, where the devices are visible to each other on the micro-segmented network and devices on other micro-segmented networks are not visible. Furthermore, the micro-segmented networks are access point 110 agnostic, wherein a first device on the micro-segmented network may be connected through a first access point and a second device on the same micro-segmented network is connected through a second access point.

The capabilities of the micro-segmented network and the devices on the micro-segmented network are set by one or more subscriber attributes. The subscription and the micro-segmented networks are configured by a NetReach system controller. Each micro-segmented network is capable of different levels of connectivity, based on both the subscriber's attributes. Subscriber attributes can include, but are not limited to, quality of service (QoS), bandwidth, data caps, up/down, operations support systems (OSS) attributes, business support systems attributes, and security models. For example, the first micro-segmented network can provide a first set of bandwidth and quality of service (QoS) attributes, while the second micro-segmented network can provide a second, different set of bandwidth and quality of service (QoS) attributes. Other attributes can include, but are not limited to, operations support systems (OSS) attributes, business support systems attributes, data caps, and security models.

In the exemplary embodiment, the system controller 108 stores the connection and identification data for each device that is a part of a micro-segmented network. The system controller 108 shares the connection and identification data with the gateway 104 and potentially the access points 110. In some embodiments, the micro-segmented networks are managed by the gateway 104. In other embodiments, the access points 110 manage the micro-segmented networks.

In some embodiments, the micro-segmented network controls the access that its devices have to the outside network 106 and/or the Internet 120. In at least one example, the micro-segmented network is associated with a workplace, where the devices are also associated with the workplace. The micro-segmented network can provide secure access to one or more servers and/or websites associated with the workplace, but not allow access to entertainment sites. In some further embodiments, the DNS is controlled and/or limited for the devices on the micro-segmented network. This can allow the system controller 108 to control the locations and Internet Protocol (IP) addresses that the devices on the micro-segmented network are allowed to access.

In some embodiments, the different access points 110 of the mesh network 102 could be in different locations. For example, two access points 110 could be located in a first residential area, while another three access points 110 are in a second residential area, where the two residential areas are distant enough from each other that their wireless coverage doesn't overlap.

Exemplary embodiments for using micro-segmented networks may include the extendable micronetworks and subnet isolation subnetworks as potential implementations as a described in co-pending U.S. patent application Ser. No. 17/127,694, filed Apr. 28, 2021, Ser. No. 16/664,657, filed Oct. 25, 2019, Ser. No. 16/576,747, filed Sep. 19, 2019, Ser. No. 16/556,219, filed Aug. 29, 2019, Ser. No. 16/120,063, filed Aug. 31, 2018, and Ser. No. 15/443,855, filed Feb. 27, 2017, which are incorporated by reference herein.

In at least some embodiments, the system controller 108 is associated with a cable network operator. In these embodiments, the cable network operator organizes the different subscription levels of service and provides the network access. The cable network operator sets operator system rules and business system rules to organize the micro-segmented networks and subscriptions described herein.

In some further embodiments, the system controller 108 can provide access at the program level. Based on Internet Protocol (IP) addresses and ports, the system controller 108 can restrict which messages are transmitted by each device on the micro-segmented network. The rules can be set so that only certain ports and/or certain IP addresses can be accessed. For example, for a work micro-segmented network, only programs such as Word, Excel, and Outlook are allowed to access the Internet 120, and those programs are only allowed to access specific websites. In still additional embodiments, individual ports can be monitored to ensure that the data from different applications is monitored and properly treated. For example, in one micro-segmented network, a video conferencing application can be prioritized over a word processing program or email program to ensure good video quality.

In the exemplary embodiment, gateways 104 capture inbound traffic from the outside network 106. This allows the gateway to effectively create a new SSID. The gateways 104 use software defined networks (SDN) s to create the individual micro-segmented networks. The gateways 104 identify each device, such as device A 112, device B 114, and device C 116, during onboarding and assign each device to the correct micro-segmented network. The gateways 104 also identify each device to the back-end systems, including the access points 110 and the system controller 108, for example. Since the gateways 104 receive all of the inbound traffic, they are able to properly route to the correct device in each of the micro-segmented networks. The gateways 104 can each track multiple micro-segmented networks in the mesh network 102, where each micro-segmented network includes multiple devices.

Furthermore, the gateways 104 are capable of determining the metering and provisioning for each device as described further herein. When a new device connects to the mesh network 106 using an SSID and password provided by the system controller 108, the gateway 104 can identify the device, secure it, authenticate it, and provide a custom network experience to the device based on the attributes of its micro-segmented network.

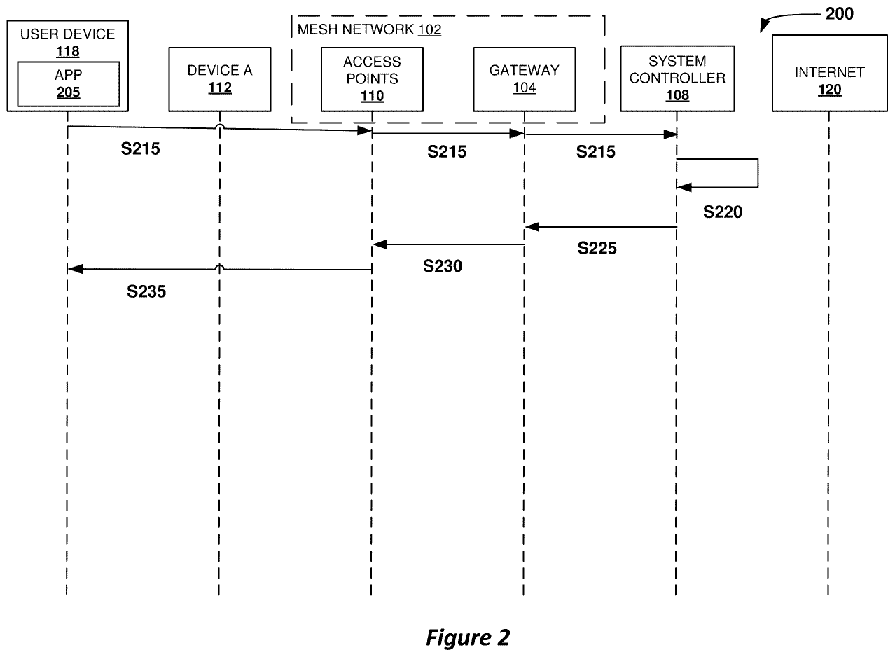

FIG. 2 illustrates a timing diagram of a process 200 for activating a subscriber account for the mesh network 102 (shown in FIG. 1). In the exemplary embodiment, user device 118 includes an app 205 for communicating with the system controller 108. In some embodiments, the app 205 is a web-browser, and the user device 118 can access a website to communicate with the system controller 108. In the exemplary embodiment, user device 118 connects to the mesh network 102 via access points 110, which can provide wired and/or wireless connections. In some embodiments, the gateway 104 and the access point 110 are separate devices. In other embodiments, the gateway 104 and the access point 110 are in the same device.

In the exemplary embodiment, the mesh network 102 includes a plurality of access points 110 in communication with one or more devices, such as device A 112, device B 114, and device C 116 (all shown in FIG. 1).

In step S215, the user device 118 connects to the mesh network 102 and transmits a request to connect with the system controller 108. The user device 118 is associated with a subscriber. The access points 110 forward the request to the gateway 104, which in turn routes the message to the system controller 108. The request information may include subscription information, such as subscriber payment information that allows the subscriber to create and/or update their subscription. In step S220, the system controller 108 analyzes the information in the request to determine if the request is valid. If the request is valid, then the system controller 108 updates the subscriber information including subscription. For example, the request can include a code giving the subscriber five days of access for up to five devices. The code can be provided as an alphanumeric code or as a scanned bar code or QR code. If the subscriber already has access then the code would extend their access by five days, for example. In addition to limited time use codes, the user can also set-up accounts that allow for a recurring subscription to be paid from an account, such as a payment card account and/or a banking account.

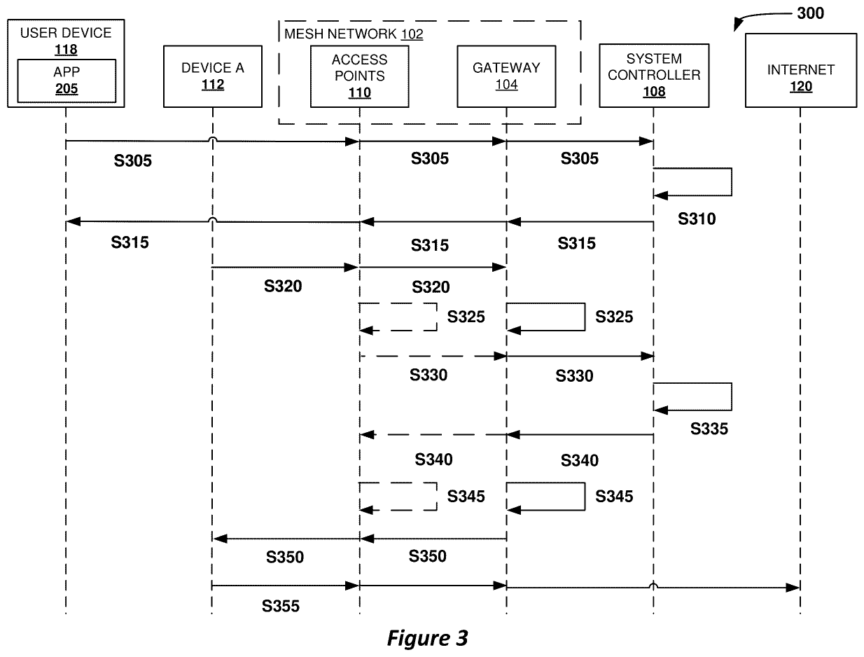

If the subscription is new or had previously expired, in step S225, the system controller 108 instructs the gateway 104 to set-up a micro-segmented network for the subscriber. The subscriber's micro-segmented network will only allow access for devices that the subscriber specifically sets up with the system controller 118, as shown in process 300 (shown in FIG. 3).

In some embodiments, in step S230, the gateway 104 informs the access points 110 on the mesh network 102 of the micro-segmented network for the subscriber. In step S235, the access point 110 informs the user device 118, via the app 205 of the updates to the subscription from the system controller 108. In some embodiments, the user can use process 200 to upgrade and/or change the subscription. In at least one embodiment, process 200 can be used to add more time for the subscription.

In a further embodiment, a micro-segmented network could be configured for a school. The students are provided with access to the school micro-segmented network. The access could be provided via cards with codes or other methodology as described herein. The students could each have their own micro-segmented network where they can add or remove their devices. The micro-segmented networks then provide the students' devices with network access, but only to reach the school system servers and resources.

In some embodiments, the user device 118 and/or app 205 is capable of directly connecting to the system controller 108, such as through a cellular connection. In other embodiments, the system controller 108 is always reachable by user devices 118 and any other device that attaches to the mesh network 102.

In some further embodiments, there is a system controller 108 associated with each mesh network 102. Furthermore, there is also a NetReach server that provides the capability to handle the billing for the subscriptions. This NetReach server is in communication with the plurality of system controllers 108 and provides information about whether or not the different subscriptions are valid and how long the subscriptions last. In these embodiments, the NetReach server can determine which mesh network 102 that the user is associated with and communicate with the corresponding system controller 108 to set-up the corresponding micro-segmented network.

FIG. 3 illustrates a timing diagram of a process 300 for adding a device to the subscriber account the mesh network 102 (shown in FIG. 1). In process 300, the subscriber associated with the user device 118 has set-up a subscription with the system controller 108, and the system controller 108 has set-up a micro-segmented network for the subscriber.

In step S305, the user device 118, via the app 205, has requested an access code for connecting a first device, device A 112. The request is forwarded through the access points 110 and gateway 104 of the mesh network 102 to the system controller 108. In step S310, the system controller 108 determines which code to provide. In at least one embodiment, the code is a pre-shared key (PSK) which will only be associated with device A 112. The system controller 108 stores a PSK for each potential device that may be added to each micro-segmented network. For example, for the first micro-segmented network associated with the first subscriber, there may be the capability to connect up to five devices. For each of those five device slots, the system controller 108 creates and/or stores a PSK. The PSK is uniquely associated with the corresponding device. In some embodiments, the system controller 108 generates the PSKs when the subscription is activated, as illustrated in process 200 (shown in FIG. 2). In other embodiments, the system controller 108 generates the PSK on demand. In step S315, the system controller 108 transmits the PSK for the first device, which is forwarded to the user device 118.

In step S320, a user, such as the subscriber, attempts to connect device A 112 to the mesh network 102 and the micro-segmented network associated with the subscriber. The user enters the SSID for the mesh network 102 and the PSK provided by the system controller 108 as the password for the network. The SSID is the same for all devices on the mesh network 102; however, each password is unique for each device.

In some embodiments, the connection sequence is performed by the access point 110. In other embodiment, the connection sequence is performed by the gateway 104. In at least one embodiment, the system controller 108 provides the IP addresses and the preassigned PSK for each potential device on each micro-segmented network. In some of these embodiments, the IP addresses and preassigned PSKs are stored in each access point 110 and the gateway 104. In other of these embodiments, the IP addresses and the preassigned PSKs are just stored in the gateway 104. The IP addresses and preassigned PSKs can be shared to the individual access points 110 as needed. While, the IP address and preassigned PSK for each device slot is known, the MAC address is not known until the device connects and is onboarded into the micro-segmented network.

In the exemplary embodiment, step S320 initiates the WPA four-way handshake. When the user enters the PSK on device A 112, device A 112 attempts to authenticate with the host APD on the access point 110. During step S325, which is where the access point 110 and/or the gateway 104 initiates the message 2 exchange of the WPA four-way handshake, the access point 110 and/or gateway 104 grabs the values provided by the device A 112 and transmits those values to the system controller 108, as shown in step S330. The values can include, but are not limited to, anonce, snonce, device A MAC address, access point MAC address, SSID, and PSK. In some embodiments, the entire access request message is forwarded to the system controller 108. In step S335, the system controller 108 uses the provided information to look-up the device. The system controller 108 knows the neighborhood based on the SSID and/or the access point MAC address. The system controller 108 also knows all of the PSKs of all of the devices that are configured to be in that neighborhood. The system controller 108 uses the PSK that was provided in the password field on device A 112 to look up the corresponding micro-segmented network. If the values correspond to a known device, in step S340, the system controller 108 returns the vlan and deviceID for the host APD to continue the authentication process. The system controller 108 also transmits an update to the AP 110 and/or gateway 104 including the MAC address for device A 112, so that the AP 110 and/or gateway 104 can perform internal associations.

In step S345, the AP 110 and/or the gateway 104 completes the authentication process/four way handshake. The APs 110 and/or gateway 104 defines the micro-segmented network to include device A 112. Furthermore, the APs 110 and/or gateway 104 can define each micro-segmented network to be on a different subnet, so that each micro-segmented network can be considered a discrete network. When the authentication is complete, an authentication success message is transmitted to device A 112, in step S350.

Next device A 112 gets an IP address assigned to it for the micro-segmented network. Then in step S355, device A 112 can access the Internet 120 based on the attributes and limitations of its micro-segmented network. Attributes can include, but are not limited to, quality of service (QoS), bandwidth, data caps, up/down, operations support systems (OSS) attributes, business support systems attributes, and security models

Additional devices can be added to the micro-segmented network based on the number of available device slots allowed by the system controller 108.

Devices can be removed from the micro-segmented network, by having a user device 118 access the system controller 108 and remove the device from micro-segmented network via the app 205. The system controller 108 then notifies the APs 110 and/or the gateway 104, that the device has been removed. The APs 110 and/or the gateway 104 informs the device that it has been removed. The APs 110 and/or the gateway 104 update their internal tables so that the device can no longer connect, as it has no credentials. The device will attempt to reconnect and then give up after a predetermined number of tries.

Any device web-capable device could be added to a micro-segmented network, as long as there is a slot available for that device. For example, user device 118 could be added to any of the first, second, or third micro-segmented networks.

In at least some embodiments, the system controller 108 meters the connections provided by the micro-segmented networks to ensure that each subscriber's micro-segmented network receives the appropriate network capacity. For example, a first subscriber and a second subscriber could both have 25 down and 10 up access. The system controller 108 monitors the behavior of the gateway 104 and/or the APs 110 to ensure that the two micro-segmented networks each receive the appropriate network bandwidth. Furthermore, the system controller 108 can also monitor the two micro-segmented networks to ensure that they don't exceed those parameters to the detriment of others on the mesh network 102.

In some embodiments, the NetReach architecture 100 (shown in FIG. 1) allows the user to travel to different locations on the network. For example, two mesh networks 102 at two locations could be associated with the same cable network provider. For this example, device A 112 is registered with a micro-segmented network on the first mesh network 102. If device A 112 travels to and then attempts to connect to the second mesh network 102, the system controller 108 can access a database of devices for approved micro-segmented networks and recognize device A 112 based on device A's SSID and password.

In some further embodiments, there is a system controller 108 associated with each mesh network 102. Furthermore, there is also a NetReach server that provides the capability to handle the billing for the subscriptions. This NetReach server is in communication with the plurality of system controllers 108 and provides information about whether or not the different subscriptions are valid and how long the subscriptions last. In these embodiments, the NetReach server is contacted by the user to set-up the individual devices in the mesh network 102 and the micro-segmented network. The NetReach server provides the necessary login information for device A 112, including the SSID and password.

In some embodiments, micro-segmented networks may include one or more policies that describe the operation of the micro-segmented network. In these embodiments, the policies can dictate how the devices on the micro-segmented network will behave as well as how the micro-segmented network will behave. These policies can be for the device A 112, the mesh network 102, the access points 110, and/or the gateway 104. For example, a policy may describe that only traffic from specific ports of device A 112 may be transported over the micro-segmented network or that only traffic to and from specific sites on the Internet 120 or outside network 106 may be accessed. Other policies may include, but are not limited to, bandwidth considerations, number of devices that can be active on the same time, restricted network locations, allowed network locations, security protocols, OSS and BSS rules, and/or any other policies desired.

In the exemplary embodiment, each device has a device specific password that is provided by the system controller 108. After the device is connected as shown in process 300, the device specific password is tied to the corresponding device's MAC.

In some additional embodiments, additional authentication elements for the device can be provided including digital certificates and private keys that can be used to authenticate the device 112 when it connects or reconnects to the mesh network 102 and its assigned micro-segmented network.

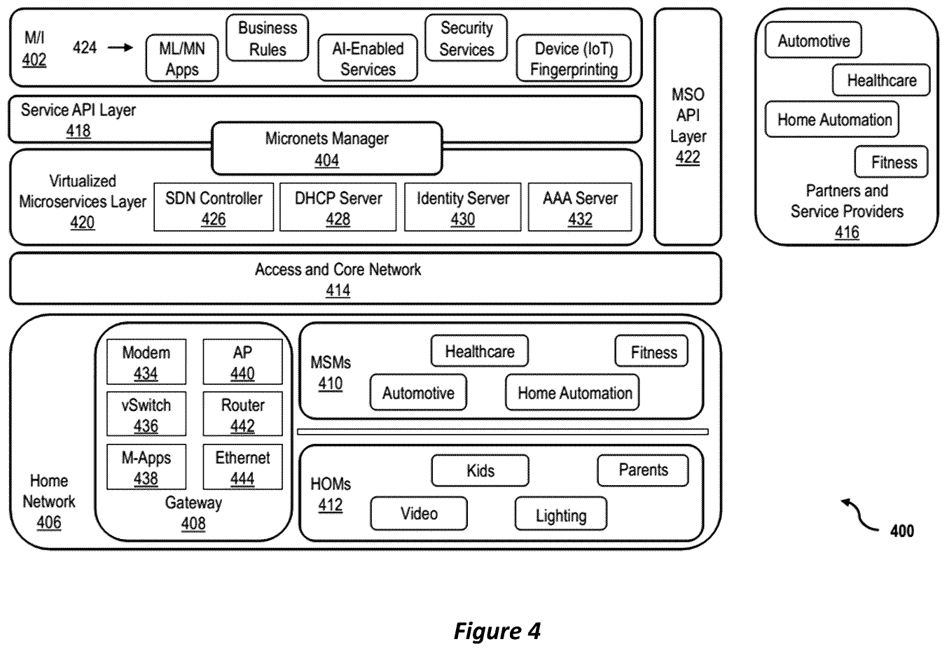

FIG. 4 is a schematic illustration depicting an exemplary micronetwork architecture 400. In an exemplary embodiment, architecture 400 may be implemented within the context of a larger networking system such as those described above with respect to the co-pending applications incorporated by reference herein. Accordingly, architecture 400 may further include several elements that are similar in structure and/or functionality to such micronetworking systems, including without limitation, a micronetwork infrastructure 402, a micronetwork manager 404, a home network 406 including a gateway 408, managed services micronetworks 410, and home owner micronetworks 412. Architecture 400 may further function with respect to an access and core network 414 and partner/service provider subsystems 416.

In an exemplary embodiment, architecture 400 further includes a service API layer 418 and a virtualized microservices layer 420 between micronetwork infrastructure 402 and access/core network 414, and an MSO API layer 422 for interfacing with partner/service provider subsystems 416.

In the exemplary embodiment depicted in FIG. 4, micronetwork infrastructure 402 represents an intelligent services layer configured to provide service information and/or guidance to the SDN or micronetwork controller to establish flow rules dynamically at the SDN switch. The intelligent services layer may include one or more advanced services 424, such as machine learning (ML) or neural network (NN) powered applications, business logic (e.g., conditional billing), AI-enabled services, security services, and/or device (e.g., IoT) fingerprinting. These services are described by way of example, and are not intended to represent an exhaustive list.

In an exemplary embodiment, virtualized microservices layer 420 represents a virtualized control layer for the microservices of one or more of an SDN controller 426, a DHCP server 428, an identity server 430, and an AAA server 432. In at least one embodiment, one or more of the microservices of virtualized microservices layer 420 may be cloud services, or operate from the cloud. Gateway 408 may thus include one or more of a modem 434, a virtual switch (VSwitch) 436, a micronetwork application layer 438, an AP 440, a router 442, and an ethernet 444. In this example the several managed services micronetworks 410 of home network 406 correspond to the respective environments of the several third party providers of partner/service provider subsystems 416.

FIG. 5 is a schematic illustration depicting an exemplary functional diagram 500 for a NetReach deployment utilizing a micronetwork configuration. As illustrated in FIG. 5, the NetReach deployment configuration of diagram 500 is similar, in several aspects, to architecture 400, FIG. 4. Accordingly, where common or similar components of diagram 500 utilize the same naming convention as relevant components of architecture 400, the person of ordinary art will understand that these common components share a similar structure and/or functionality.

Thus, in the embodiment depicted in FIG. 5, diagram 500 similarly includes a micronetwork infrastructure 502, a service API layer 504, and a virtualized microservices layer 506, all of which may operatively communicate with external APIs 508, which may in include one or more registration APIs 510. Also similar to architecture 400, an intelligent services layer of micronetwork infrastructure 502 may include one or more advanced services 512, such as OSS/BSS applications, business rules/logic, security services, etc., and virtualized microservices layer 506 may include an SDN controller 514 and a DHCP server 516.

Diagram 500 though, depicts an exemplary scenario of NetReach deployment within a Cloud environment similar to the examples described above. Accordingly, in the exemplary embodiment depicted in FIG. 5, micronetwork management functionality is performed by a Cloud orchestrator 518 logically disposed between service API layer 504 and virtualized microservices layer 506. Further to this example, virtualized microservices layer 506 may additionally include one or more of a Cloud NetReach authentication server (AS) 520, an AP/ESS manager 522, and a credential manager 524.

Also in this NetReach deployment example, a local server layer 526 may be disposed remotely from micronetwork infrastructure 502, Cloud orchestrator 518, and the several Cloud-based elements of virtualized microservices layer 506. As described above, local server layer 526 may include one or more local counterparts to virtualized microservices layer 506, including but not limited to, a local DHCP server 528, a local NetReach AS 530, and one or more control applications 532. As may be further seen from diagram 500, an individual gateway device is not needed at the local level to establish and manage multiple VLANs 532 for various respective subscribers.

That is, local server layer 526 may communicate with one or more NetReach APs, namely, CloudReach AP 534 in the exemplary embodiment depicted in FIG. 5, and each such NetReach/CloudReach AP 534 is enabled to individually manage one or more subscriber devices 536 within each single VLAN 532 established for each subscriber connecting to the particular NetReach/CloudReach AP 534. Accordingly, each NetReach/CloudReach AP 534 may include a virtual switch 538, as well as a device AP (e.g., a Wi-Fi layer AP) 540 for direct communication to and from individual subscriber devices 536. In the Cloud-based embodiment depicted in FIG. 5, NetReach/CloudReach AP 534 may further include a MC2UC Proxy ARP 542.

Thus, according to diagram 500, multiple NetReach/CloudReach APs 534 may be advantageously configured to form a mesh, and thereby operate in a mesh architecture. In the exemplary embodiment, each such NetReach/CloudReach AP 534 may be further configured to have a persistent management channel Cloud orchestrator 518, and each SSID within the mesh architecture may then be a portion of an ESS that is established and managed from the Cloud. In some embodiments, an individual AP may be a part of more than one ESS simultaneously.

In an exemplary embodiment, each AP 534 may further incorporate an SDN logical switch to which Wi-Fi layer device AP 540 is bridged. In some embodiments, AP 534 supports DHCP-relay with support for DHCP Option 82 along with Subscriber-Id sub-option 6 (RFC3993). In at least one embodiment, AP 534 supports multicast-to-unicast modes of transmission and Proxy ARP (e.g., Proxy ARP 542). In an exemplary embodiment, a Wi-Fi module on the AP (e.g., device AP 540) supports 802.1Q VLAN tagging and WMM.

In an exemplary embodiment, AP 534 thus functions as the WAP module, and incorporates the relevant Wi-Fi hardware and associated AP software (e.g., hostapd). In the exemplary embodiment, the relevant Wi-Fi chipset and software (not separately shown) may be Wi-Fi 5 or higher, and with support for 802.1Q tagging, WMM, multicast-to-unicast conversion, and at least 8 virtual SSIDs.

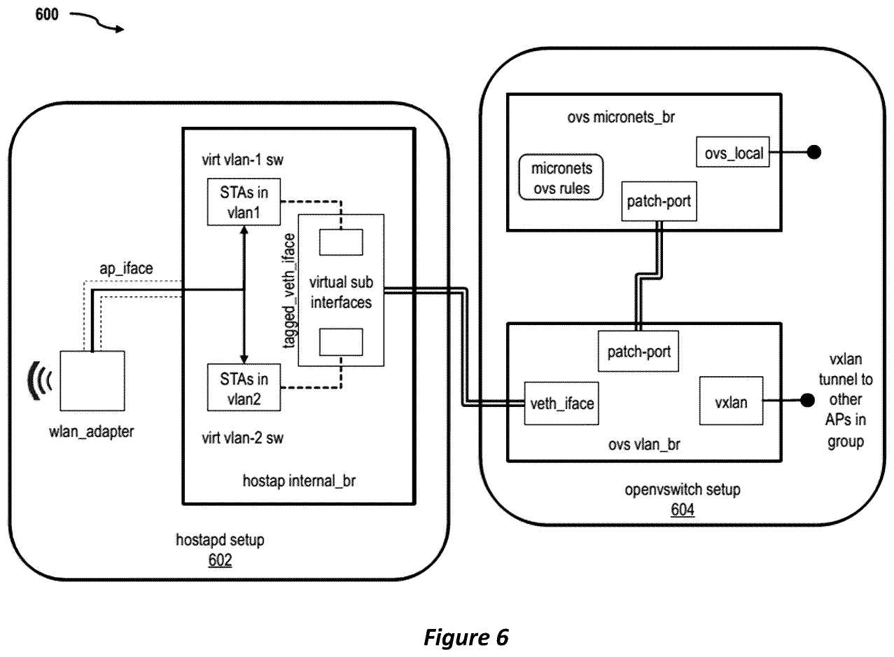

In an exemplary embodiment, virtual switch 538 may be a software defined switch (e.g., OpenVSwitch, or OVS) to which the particular AP 534 bridges each STA (e.g., subscriber devices 536) connecting to that AP. A virtual port interface (see e.g., FIG. 6, below) may then be created for each STA that connects to the AP, with the traffic therebetween being managed by rules enforced in virtual switch 538.

In an exemplary embodiment, NetReach AS 520 may function as the component responsible for resolving a password used by a subscriber device 536 while the device is associating and authenticating with the network, and also for determining the device eligibility, subscriber information, and/or relevant subscription tier. In some embodiments, Cloud NetReach AS 520 is implemented as a distributed service having a local component (e.g., local NetReach AS 530) to speed the authentication process.

In an embodiment, credential manager 524 may function as the component responsible for managing the subscriber account, and for integration with the OSS/BSS applications of advanced services 512. AP/ESS manger 522, on the other hand, may virtually serve as the functional equivalent of a wireless controller for managing the AP(s) 534 and ESS/SSIDs. Exemplary bridge and port configurations are described further below with respect to FIG. 6.

FIG. 6 is a schematic illustration depicting an exemplary trust domain configuration 600 utilizing a HostAP and an OpenVSwitch (OVS). In the embodiment depicted in FIG. 6, configuration 600 illustrates one exemplary network bridge and port scenario enabling the HostAP and the OVS to segment connecting STAs into separate trust domains, i.e., micronetworks, according to the embodiments described herein.

In this illustrative example, configuration 600 includes a hostapd sub-configuration, or setup, 602, as well as the bridges and ports used therein, and an OVS setup 604. In exemplary operation of configuration 600, at the start of hostapd, hostapd setup 602 sets up an AP mode (e.g., ap_iface) on a particular wireless interface specified in a hostap.conf file. In an embodiment, hostapd setup 602 further creates an internal bridge on which it creates a controlled port for each STA that associates with the AP. Accordingly, in the case where the HostAP is configured to enable dynamic_vlan in a hostap.conf file, the HostAP may then be further advantageously configured to create an internal switch for each VLAN, as well as for each STA that is associated with the particular VLAN, which connects the controlled port of the STA to the corresponding VLAN switch.

In further exemplary operation, the HostAP is further enabled to determine the VLAN of a STA according to several mechanisms, including without limitation, a radius server, a “vlan_file” config option in hostap.conf, and/or a “wpa_psk_file” option in hostapd.conf. In some embodiments, where the wpa_psk_file contains a specific VLAN for a STA, the wpa_psk_file option may be configured to take precedence over other options/mechanisms. According to this particular NetReach setup, the configuration in the wpa_psk_file may be used as a sole source to assign each STA to a particular VLAN. Once traffic from a STA comes on the specific VLAN switch, the HostAP may then add a VLAN tag to the traffic packets, and then outputs the VLAN-tagged packet on a “vlan_tagged_interface” configuration option defined in the hostap.conf file.

In some embodiments, the HostAP creates a virtual sub-interface on the interface specified by the “vlan_tagged_interface”, and may then bridge that VLAN-specific sub-interface to the internal VLAN switch on which the STAs are connected.

In further exemplary operation, for OVS setup 604, configuration may further create a linux “veth” pair prior to starting the HostAP or the OVS. In this example, the VLAN-tagged traffic is more readily ingested and managed. Under this sub-configuration, one port of the veth pair may be connected to the HostAP by specifying that port as the “vlan_tagged_interface” in the hostap.conf file, and the other port of the veth pair may be added to an OVS VLAN bridge (ovs vlan_br), thereby enabling the outbound traffic from STAs to appear on the OVS VLAN bridge as being VLAN-tagged. The OVS VLAN bridge (brhapd) thus functions to advantageously “bridge” the VLANs on all APs in an AP group through VXLAN tunnels (vxlan port), thereby ensuring that the normal MAC learning and STP logic functions on a per-VLAN basis. According to exemplary configuration 600, only one VXLAN tunnel thus needs to be created between each AP pair in the AP group, and irrespective of the number of VLANs that are actually created.

In further exemplary operation of configuration 600, the OVS VLAN bridge may be connected to an OVS micronetworks bridge (brmn001) through an OVS patch-port pair. According to this embodiment, the OVS micronetworks bridge contains the OVS flow rules that enforce the micro-segmentation logic, and thereby further ensure that traffic is isolated per micronetwork/VLAN. In some embodiments, the OVS micronetworks bridge may be further advantageously configured to perform several additional tasks, including without limitation, connection tracking, VLAN tag handling, etc., prior to egress through the OVS LOCAL port.

### Wireless Network Extender Onboarding

Disclosed herein are methods for onboarding a wireless network extender in a NetReach system. Particular embodiments of the methods enable a wireless network extender to be individually authenticated, automatically configured using device-unique credentials, and individually removed from a wireless network. For example, in certain embodiments, a wireless network extender may be onboarded to a wireless network using pre-defined credentials, such as a single-device PSK, a X.509 certificate, or a public key, which directly or indirectly indicate that the wireless network extender is also a wireless access point and allow for further provisioning and configuration of the wireless network extender. For instance, credentials of a wireless network extender may indicate one or more (a) what customer the wireless network extender is associated with, (b) how and where the wireless network extender should forward its traffic to, and (c) what traffic the wireless network extender should forward. Furthermore, certain embodiments of the NetReach systems are configured to determine how to route data associated with a wireless network extender at least partially based on information determined from onboarding the wireless network extender.

It is understood, though, that the NetReach systems disclosed herein are not limited to onboarding a wireless network extender as discussed below. To the contrary, the NetReach systems disclosed herein could instead be configured to onboard a wireless network extender using other methods.

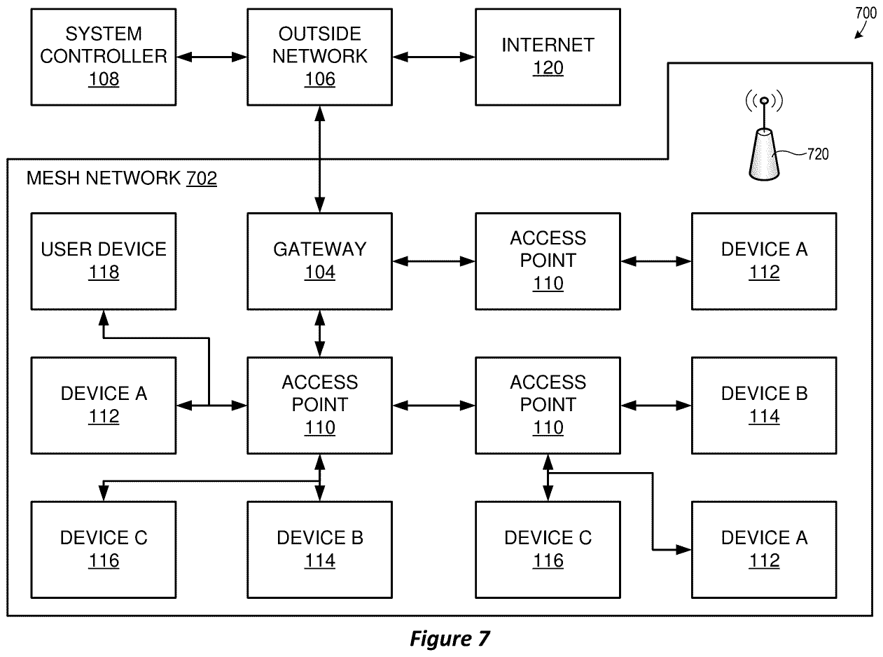

FIG. 7 illustrates a NetReach architecture 700, where NetReach architecture 700 is an alternate embodiment of NetReach architecture 100 (FIG. 1) including a mesh network 702 in place of mesh network 100. Mesh network 702 differs from mesh network 102 in that mesh network 702 further includes a wireless network extender 720 awaiting onboarding to the NetReach system of FIG. 7. In certain embodiments, wireless network extender 720 is a Wi-Fi extender, and wireless network extender 720 is primarily discussed below in the context of being a Wi-Fi extender. However, it is understood that wireless network extender 720 could be another type of wireless network extender. For example, some embodiments of wireless network extender 720 are configured to extend one or more of a cellular wireless network (e.g., operating according to a 3GPP communication protocol, such as an LTE, a 5G, or a 6G communication protocol), a satellite communication protocol, a Bluetooth communication protocol, a long range (LoRa) wireless communication protocol, a Zigbee wireless communication protocol, a Z-Wave wireless communication protocol, or a Wi-Fi direct wireless communication protocol.

One or more device in mesh network 702 are wireless client devices, and one or more of access points 110 in mesh network 702 are wireless access points. Accordingly, mesh network 702 is at least partially a wireless mesh network. Wireless network extender 720 is configured to extend the range of an access point 110 in mesh network 702 by wirelessly relaying data between the access point 110 and one or more devices, e.g., device A 112, device B 114, device C 116, and/or user device 118. Wireless network extender 720 has a Service-specific SSID that represents a wireless network supported by wireless network extender 720 that devices may connect to. In certain embodiments, the Service-specific SSID is different from the group SSID of access points 110, such as to limit use of wireless network extender 720 to devices associated with a particular subscriber. The group SSID of access points 110 represents wireless networks supported by access points 110 to which devices may connect. Devices may connect to either the Service-specific SSID network or the group SSID network. For example, app 205 on user device 118 may select one of the Service-specific SSID or the group SSID to connect to according to whichever of the two SSIDs is associated with a stronger received signal strength. In some other embodiments, the Service-specific SSID is the same as the group SSID of access points 110, such as to enable any authorized device of NetReach architecture 700 to use wireless network extender 720. In particular embodiments of the NetReach systems disclosed herein, use of wireless network extender 720 to connect to mesh network 702 does not affect number of device slots available to a subscriber. Additionally, system controller 108 may present a device list to a subscriber via app 205 in the same manner irrespective of whether the subscriber's devices are connected to an access point 110 or to wireless network extender 720.

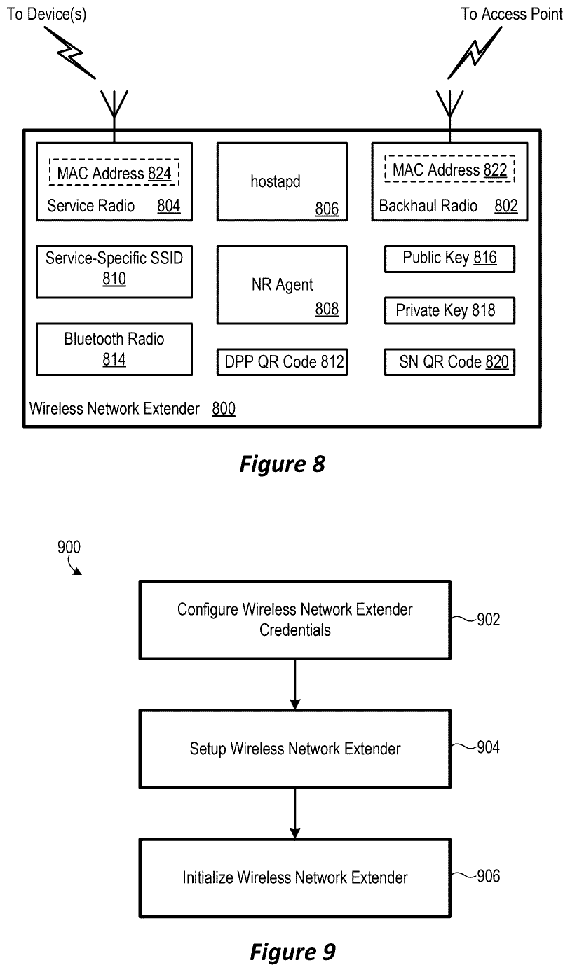

FIG. 8 is a block diagram of a wireless network extender 800, which is one possible embodiment of wireless network extender 720 of FIG. 7. Wireless network extender 800 includes a backhaul radio 802, a service radio 804, a hostapd 806, a NetReach Agent (NR Agent) 808, and a Service-specific (SS) SSID 810 for representing a wireless network supported by wireless network extender 800. Wireless network extender 800 optionally further includes one or more of Device Provisioning Protocol (DPP), also known as Easy Connect, QR code 812, a Bluetooth radio 814, a public key 816, a private key 818, and a serial number (SN) QR code 820. Backhaul radio 802 includes a MAC address 822, and backhaul radio 802 is configured to (a) wirelessly send uplink data to an access point 110 and (b) wirelessly receive downlink data from an access point 110. Service radio 804 includes a MAC address 824, and service radio 804 is configured to (a) wirelessly send downlink data to one or more devices and (b) wirelessly receive uplink data from one or more devices. Certain embodiments of backhaul radio 802 and service radio 804 support a Wi-Fi Protected Access (WPA) security protocol, such as WPA-2 security protocol, a WPA-3 security protocol, or successors thereof. Wireless network extender 800 is configured to pass or bridge device packet MAC addresses between service radio 804 and backhaul radio 802 without modifying the device packet MAC addresses.

Hostapd 806 supports a NetReach PSK lookup delegate. NetReach agent 808 is capable of invoking PSK lookups on system controller 108 as well as provisioning passphrase-MAC-VLAN WPA entries. In some embodiments, Hostapd 806 is configured to manage and configure authentication, encryption, access control, SSID operation, and/or radio resource management (e.g., channel used, channel bandwidth used, transmit power used, etc.). One or more of optional DPP QR code 812, Bluetooth radio 814, public key 816, private key 818, and serial number QR code 820 are used to convey credentials of wireless network extender 800, as discussed below.

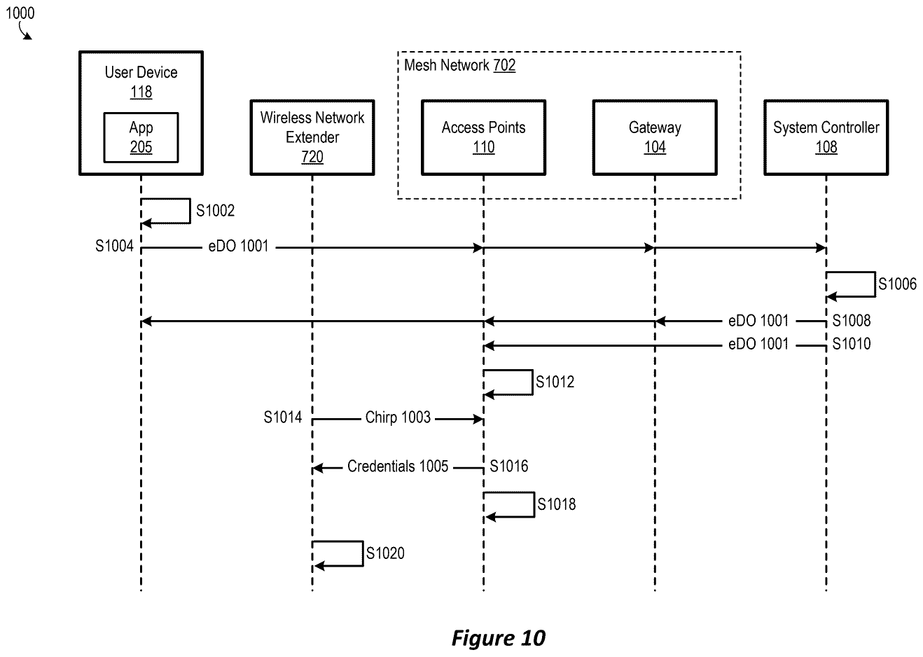

Referring again to FIG. 7, particular embodiments of the NetReach systems disclosed herein are configured to onboard wireless network extender 720 using a procedure similar to that for onboarding of other types of wireless client devices. For example, FIG. 9 is a flowchart of a method 900 for onboarding wireless network extender 720, which is one embodiment of the methods disclosed herein for onboarding a wireless network extender in a NetReach system. In a block 902 of method 900, credentials of wireless network extender 720 are configured, such as by providing a SSID and a passphrase to wireless network extender 720, to enable wireless network extender 720 to connect to any access point 110 of mesh network 702. Discussed below with respect to respect to FIGS. 10-12 are several example embodiments of block 902. However, block 902 may be executed in other manners without departing from the scope hereof.

FIG. 10 is a timing diagram illustrating a method 1000 for configuring credentials of wireless network extender 720 using DPP, where method 1000 is one example of block 902 of method 900. FIG. 10 includes dashed lines logically representing each of user device 118, wireless network extender 720, access points 110, gateway 104, and system controller 108. Method 1000 assume that (a) wireless network extender 720 includes DPP QR code 812, (b) DPP QR code 812 includes DPP bootstrapping information, such as public key 816, and (c) wireless network extender 720 is ready for DPP onboarding at power on. However, wireless network extender 720 is not limited to this configuration. In a step S1002 of method 1000, a user engages app 205 of user device 118 to scan DPP QR code 812, and app 205 creates an extender Device Object (eDO) 1001 under a Service associated with the user. Extender Device Object 1001 includes a “dppQrCode” field which is set to scanned DPP QR code 812. In a step S1004 of method 1000, app 205 sends extender Device Object 1001 to system controller 108 via one or more access points 110 and gateway 104.

In a step S1006 of method 1000, system controller 108 (a) verifies that DPP QR code 812 is not associated with another wireless network extender, (b) generates a passphrase for wireless network extender 720 and adds it to extender Device Object 1001, (c) generates a Service-specific SSID for wireless network extender 720 and adds it to extender Device Object 1001, (d) assigns an IP address to wireless network extender 720 and adds it to extender Device Object 1001, and (e) sets a “configured=False” flag in extender Device Object 1001. System controller 108 returns extender Device Object 1001 to app 205 in a step S1008 via gateway 104 and one or more access points 110. App 205, for example, reads extender Device Object 1001 and determines that a wireless network extender is being onboarded. In response thereto, app 205 may provide one or more user interface screens for a user to configure wireless network extender 720, where the user interface screens may be different than user interface screens provided for other types of network clients. In a step S1010 of method 1000, system controller 108 notifies all access points 110 of the onboarding of wireless network extender 720 by sending extender Device Object 1001 to each access points 110 via gateway 104, such as by using a message queuing telemetry transport (MQTT) protocol.

In a step 1012 of method 1000, each access point 110 (a) receives a notification of a change in a device list under the Service associated with the user, (b) recognizes presence of non-configured wireless network extender 720, and (c) begins listening for DPP presence announcements (“chirps”), in response to receiving extender Device Object 1001 from system controller 108. In a step S1014 of method 1000, an access point 110 nearest to wireless network extender 720 receives a chirp 1003 from wireless network extender 720. In a step S1016 of method 1000, the access point 110 receiving chip 1003 encrypts credentials 1005 for wireless network extender 720 using public key 816, and the access point 110 sends encrypted credentials 1005 to wireless network extender 720. Credentials 1005 include, for example, the Service-specific SSID and passphrase for wireless network extender 720, as specified in extender Device Object 1001. Alternately or additionally, credentials 1005 may be sent to wireless network extender 720 using Wi-Fi Alliance (WFA) Easy Connect, WFA Unsynchronized Discovery, or another protocol. In a step S1018 of method 1000, the access point 110 receiving chirp 1003 sets a “configured=True” flag in extender Device Object 1001. In a step S1020 of method 1000, wireless network extender 720 decrypts credentials 1005 using private key 818, and wireless network extender 720 now has the necessary credentials to connect to any access point 110.

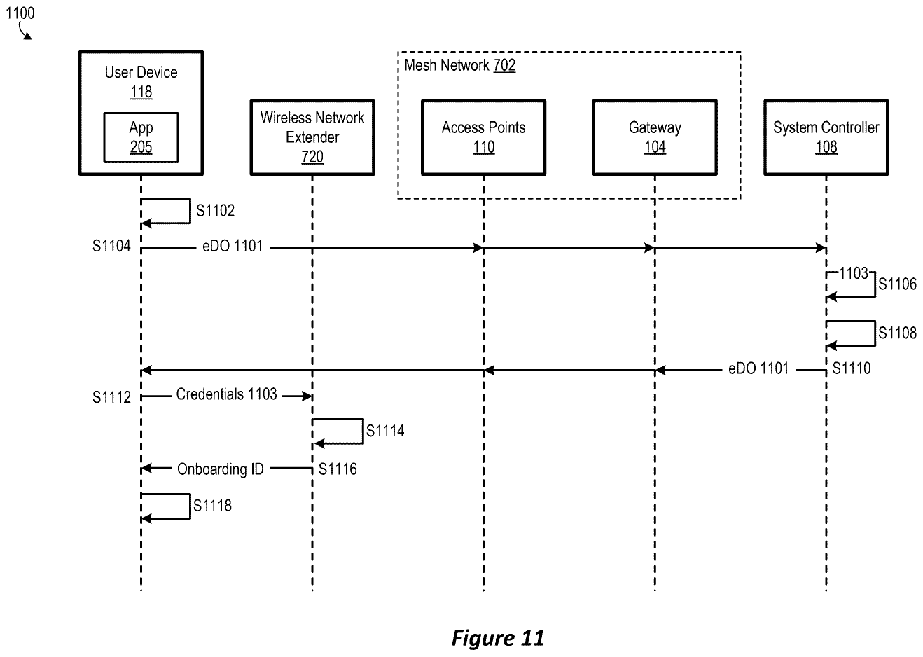

FIG. 11 is a timing diagram illustrating a method 1100 for configuring credentials of wireless network extender 720 using Bluetooth, where method 1100 is another example of block 902 of method 900. FIG. 11 includes dashed lines logically representing each of user device 118, wireless network extender 720, access points 110, gateway 104, and system controller 108. Method 1100 assume that (a) wireless network extender 720 includes Bluetooth radio 814, (b) wireless network extender 720 is ready for Bluetooth onboarding at power on, and (c) user device 118 has Bluetooth wireless communication capability. However, wireless network extender 720 and user device 118 are not limited to these configurations.

In a step S1102 of method 1100, a user engages app 205 of user device 118 to onboard wireless network extender 720, and app 205 creates an extender Device Object (eDO) 1101 under a Service associated with the user. In a step S1104 of method 1100, app 205 sends extender Device Object 1101 to system controller 108 via one or more access points 110 and gateway 104. In a step S1106 of method 1100, system controller 108 generates credentials 1103 for wireless network extender 720, and system controller 108 encrypts credentials 1103 using public key 816 of wireless network extender 720 obtained from extender Device Object 1101. Credentials 1103 include, for example, a passphrase for use by wireless network extender 720, Service-specific SSID 810, and a random onboarding identifier. In a step S1108 of method 1100, system controller 108 stores encrypted credentials 1103 and an IP address for wireless network extender 720 in extender Device Object 1101, and system controller 108 sets a “configured=False” flag in extender Device Object 1101. System controller 108 returns extender Device Object 1101 to app 205 in a step S1108 via gateway 104 and one or more access points 110.

In a step S1112 of method 1100, app 205 initiates a Bluetooth connection with wireless network extender 720, and app 205 sends credentials 1103 to wireless network extender 720 via the Bluetooth connection. In a step S1114 of method 1100, wireless network extender 720 decrypts credentials 1103 using private key 818, and wireless network extender 720 returns the decrypted random onboarding identifier to app 205 in a step S1116 of method 1100. In a step S1118 of method 1100, app 205 determines that Bluetooth configuration was successful in response to the decrypted random onboarding identifier matching a previously known plain text version of random onboarding identifier, and app 205 sets a “configured=True” flag in extender Device Object 1101. Wireless network extender 720 now has the necessary credentials to connect to any access point 110.

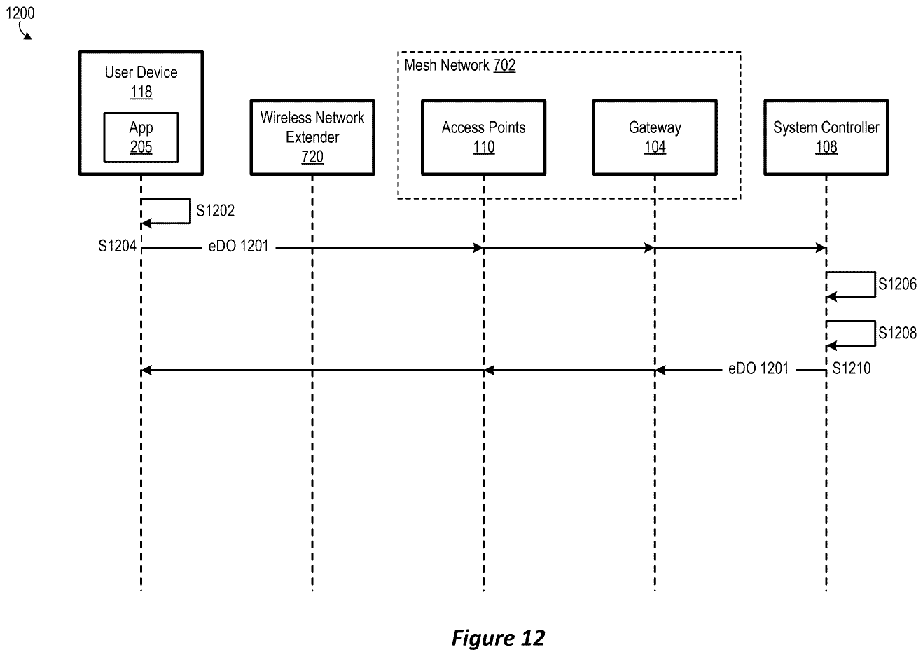

FIG. 12 is a timing diagram illustrating a method 1200 for configuring credentials of wireless network extender 720 without using DPP or Bluetooth, where method 1200 is an additional example of block 902 of method 900. FIG. 12 includes dashed lines logically representing each of user device 118, wireless network extender 720, access points 110, gateway 104, and system controller 108. Method 1200 assume that (a) wireless network extender 720 includes optional serial number QR code 820 and (b) the serial number of wireless network extender 720 is pre-associated with public key 816 (and optionally also pre-associated with MAC address 822 of backhaul radio 802) in system controller 108. However, wireless network extender 720 and system controller 108 are not limited to these configurations.

In a step S1202 of method 1200, a user engages app 205 of user device 118 to scan SN QR code 820, and app 205 creates an extender Device Object (eDO) 1201 under a Service associated with the user including the serial number of wireless network extender 720 from SN QR code 820. App 205 also sets a “configured=False” flag in extender Device Object 1201. In a step S1204 of method 1200, app 205 sends extender Device Object 1201 to system controller 108 via one or more access points 110 and gateway 104. In a step S1206 of method 1200, (a) system controller 108 verifies that the serial number is valid and is not associated with another wireless network extender, (b) system controller 108 generates a passphrase, Service-specific SSID 810, and a random onboarding identifier, and (c) system controller 108 encrypts aforesaid credentials using public key 816. In a step S1208 of method 1200, system controller 108 stores the encrypted credentials and an IP address for wireless network extender 720 in extender Device Object 1201, and system controller 108 sets a “configured=False” flag in extender Device Object 1201. System controller 108 returns extender Device Object 1201 to app 205 in a step S1210 via gateway 104 and one or more access points 110.

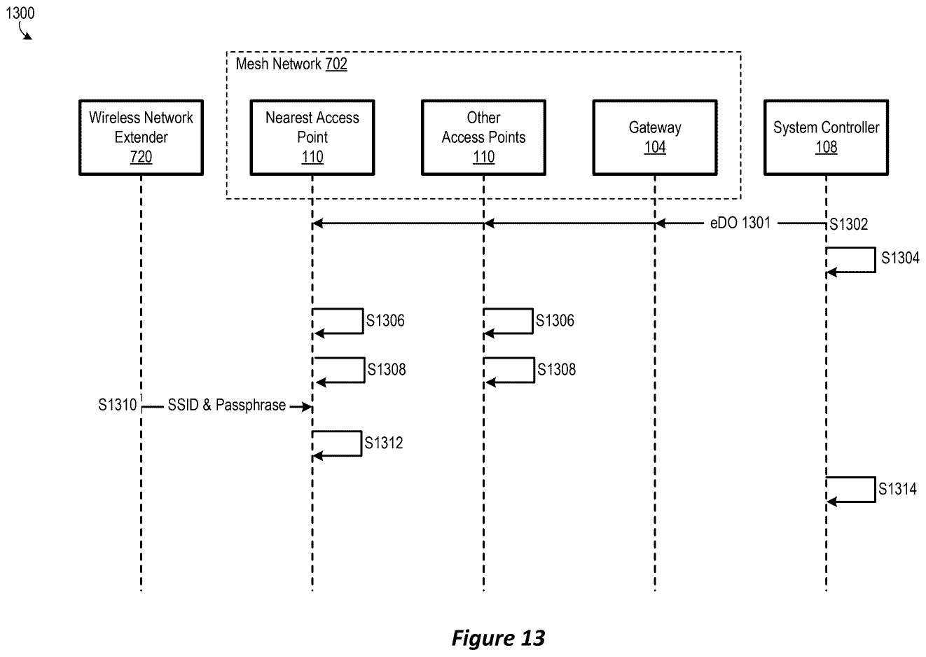

Referring again to FIG. 9, method 900 proceeds from block 902 to a block 904 where wireless network extender 702 is setup, which enables wireless network extender 720 to connect to an access point 110 using its credentials configured in block 902. FIG. 13 is a timing diagram illustrating one example of a method 1300 for setting up wireless network extender 702, where method 1300 is one example of block 904. However, it is understood that block 904 is not limited to the FIG. 13 example method. FIG. 13 includes dashed lines logically representing each of wireless network extender 720, a nearest access point 110, other access points 110, gateway 104, and system controller 108, where nearest access point 110 is an access point of mesh network 702 that is nearest to wireless network extender 720. In a step S1302 of method 1300, system controller 108 sends an extender Device Object 1301 to each access point 110, such as using a MQTT protocol, to notify access points 110 of newly configured wireless network extender 702. In some embodiments, extender Device Object 1301 is one of extender Device Objects 1001-1201 of FIGS. 10-12, respectively. Additionally, in a step S1304 of method 1300, system controller 108 adds the passphrase of wireless network extender 720 to a list of claimable passphrases for use by system controller 108, if a MAC address is not already configured for wireless network extender 720.

In a step S1306 of method 1300, each access point 110 adds the passphrase for wireless network extender 720 to a respective list of allowed Wi-Fi passphrases, in response to receiving extender Device Object 1301. Additionally, if extender Device Object 1301 includes MAC address 822 of backhaul radio 802, each access point 110 associates MAC address 822 with the user's Service VLAN, in step S1306. In an optional step S1308 of method 1300, each access point 110 adds an access control list (ACL) allowing MAC address 822 of backhaul radio 802 to have limited connectivity, e.g., dynamic host configuration protocol (DHCP) connectivity, domain name system (DNS) connectivity, and network time protocol (NTP) connectivity to gateway 104, and hypertext transfer protocol (HTTP or HTTPS) connectivity and MQTT connectivity to system controller 108, during onboarding. In a step S1310 of method 1300, wireless network extender 720 connects its backhaul radio 802 to the nearest access point 110 using its configured SSID and passphrase. Steps S1312 and S1314 of method 1300 are performed only if extender Device Object 1301 is not already configured with MAC address 822 of backhaul radio 802. In step S1312, a NetReach passphrase claiming process is used to onboard wireless network extender 720 onto nearest access point 110, and system controller 108 subsequently updates Device Object 1301 with MAC address 822 in step 1314.

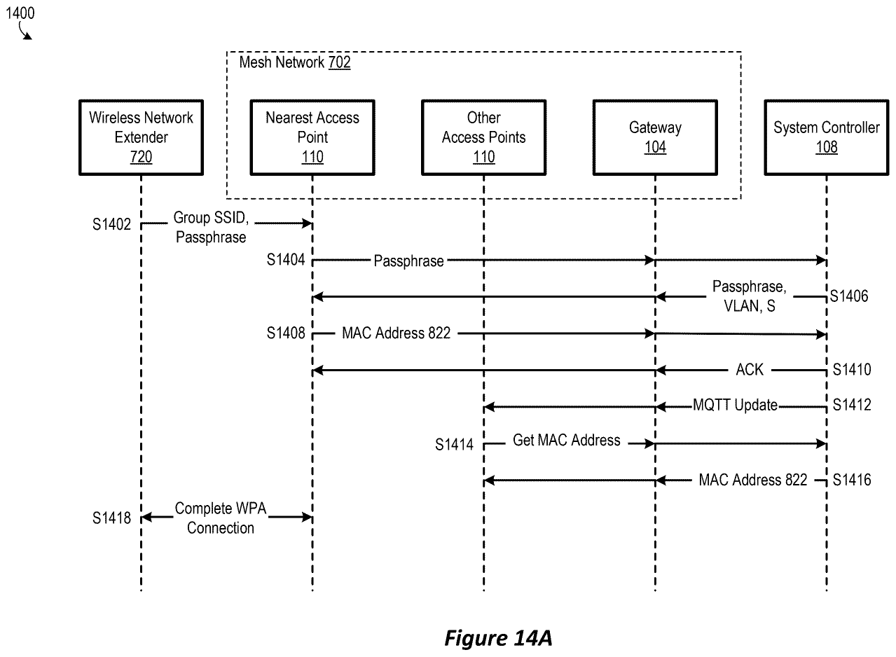

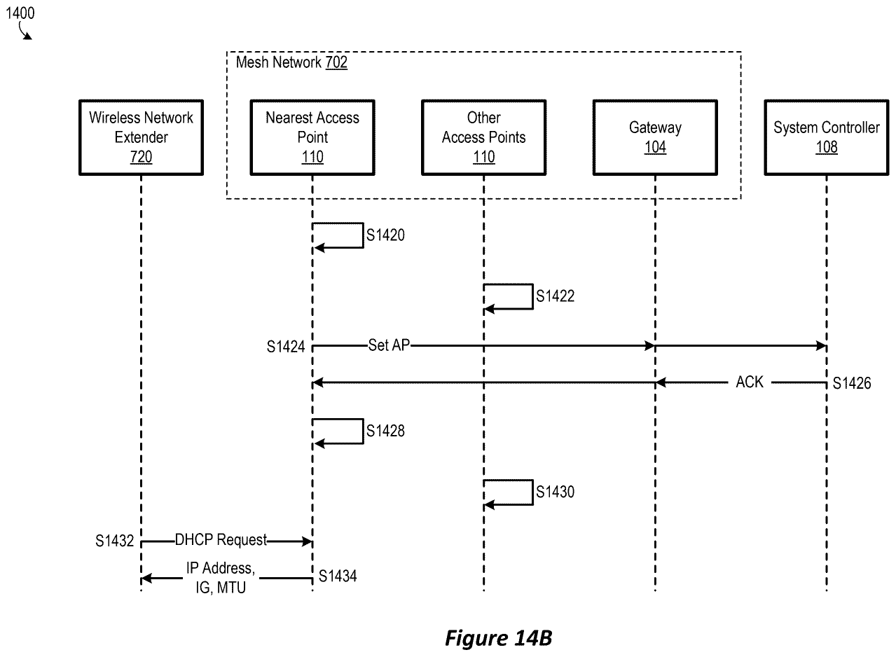

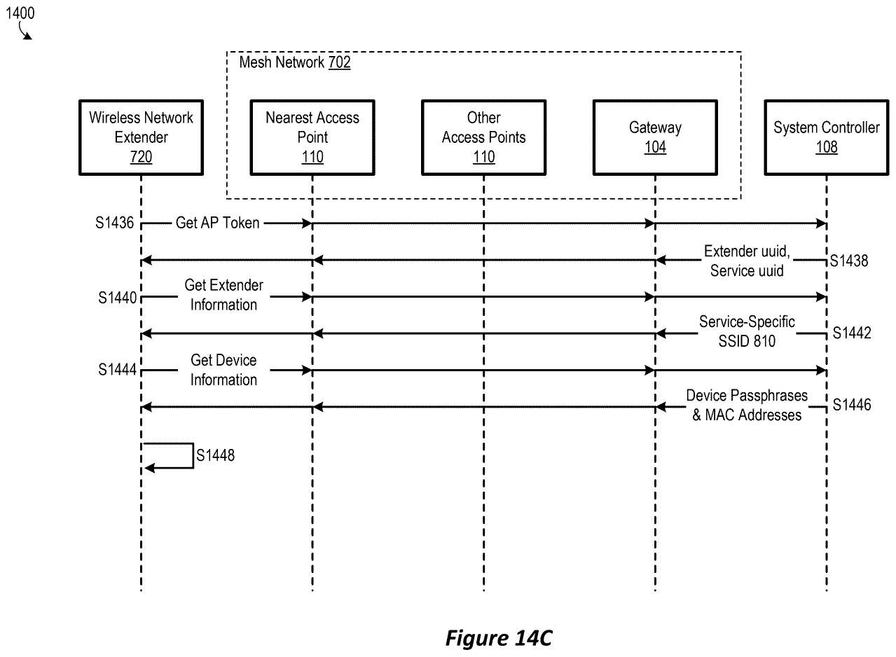

Referring again to FIG. 9, method 900 proceeds from block 904 to a block 906 where wireless network extender 720 is initialized. Block 906 is executed each time wireless network extender 720 starts up. FIGS. 14A-14C are collectively a timing diagram illustrating a method 1400 for initializing wireless network extender 720, where method 1400 is one example of block 906. However, it is understood that block 906 is not limited to the example method of FIGS. 14A-14C. FIGS. 14A-14C include dashed lines logically representing each of wireless network extender 720, a nearest access point 110, other access points 110, gateway 104, and system controller 108. In a step S1402 of method 1400, wireless network extender 720 initiates a connection to nearest access point 110 using wireless network extender 720's passphrase and the group SSID of access points 110 (group SSID). In a step 1404 of method 1400, nearest access point 110 contacts system controller 108 via gateway 104 and optionally via one or more other access points 110 to perform a lookup of wireless network extender 720's passphrase against unclaimed passphrases. Assuming that the passphrase is valid and is unclaimed, system controller 108 responds in a step S1406 of method 1400 by returning each of the passphrase, a VLAN for wireless network extender 720, and a Service S associated with the user. In a step S1408 of method 1400, nearest access point sends MAC address 822 of backhaul radio 802 to system controller 108, and in a step S1410 of method 1400, system controller 108 sends an acknowledgment (ACK) confirming receipt of MAC address 822.

In a step S1412 of method 1400, system controller 108 sends an MQTT update to other wireless access points 110, and each other wireless access point 110 responds in a step S1414 by sending a request to get the MAC address of wireless network extender 720's backhaul radio 802. In some embodiments, the MQTT update includes event type details, e.g., one or more that a device has been added, a device has been updated, a service has been updated, etc., as well as an event identifier or a service identifier associated with the event or service, respectively. In a step S1416 of method 1400, system controller 108 sends MAC address 822 of backhaul radio 802 to each other access point 110. In a step S1418 of method 1400, wireless network extender 720 and nearest access point 110 complete a WPA connection, e.g., a WPA-2, WPA-3, or higher, connection, such that nearest access point 110 accepts connection of wireless network extender 720. In steps S1420 and S1422, respectively, nearest access point 110 and other access points 110 setup micronets for wireless network extender 720 and MAC address 822 of its backhaul radio 802.

In a step S1424 of method 1400, nearest access point 110 sends a Set AP request to system controller 108 to request that system controller 108 associate nearest access point 110 with wireless network extender 720. System controller 108 confirms receipt of the Set AP request by sending an acknowledgement (ACK) to nearest access point 110 in a step S1426 of method 1400. In a step S1428 of method 1400, nearest access point 110 sets up tunnels for devices in service S that are connected to other access points 110, to the extent that such tunnels are not already set up. Similarly, in a step S1430 of method 1400, each other access point 110 sets up tunnels for devices in service S that are connected to nearest access point 110, to the extent that such tunnels are not already set up.

In a step S1432 of method 1400, wireless network extender 720 sends a DHCP request to nearest access point 110 using backhaul radio 802, and nearest access point 110 responds with an IP address for wireless network extender 720 in a step S1434 of method 1400. Nearest access point 110 optionally also sends wireless network extender 720 information on gateway 104 (IG) as well as a maximum transmission unit (MTU) for the NetReach system, in step S1434. At the conclusion of step S1434, wireless network extender 720 acts like a single-Service access point, but with DHCP, VLAN management, tunneling, etc. handled by a “parent” access point, i.e., nearest access point 110, and wireless network extender 720 handles only WPA PSK lookup and caching. Additionally, in some embodiments, wireless network extender 720 is provided a controllerBaseUrl during onboarding so that wireless network extender 720 can be onboarded onto other NetReach deployments with different system controllers.

In a step S1436 of method 1400, wireless network extender 720 sends a Get AP Token request to system controller 108, where the Get AP Token request is signed by wireless network extender 720's private key 818. In a step 1438 of method 1400, system controller 108 responds by returning an Extender universally unique identifier (uuid) and a Service uuid. In a step 1440 of method 1400, wireless network extender 720 sends system controller 108 a Get Extender Information request including the Extender uuid. System controller 108 responds in a step S1442 of method 1400 by returning Service-specific SSID 810 to wireless network extender 720 and by also indicating to wireless network extender 720 that it is enabled. In a step S1444 of method 1400, wireless network extender 720 sends system controller 108 a Get Device Information request including the Service uuid. System controller 108 responds in a step S1446 of method 1400 by returning to wireless network extender 720 passphrases and MAC addresses of all devices of Service S. In a step S1448, wireless network extender 720 (a) configures service radio 804 to match Service-specific SSID 810, (b) configures passphrase, MAC address, and VLAN associations for devices of Service S, (c) configures service radio 804 to forward all traffic for devices of Service S to wireless network extender 720, and (d) starts service radio 804. Wireless network extender 720 is now ready to onboard and accept connections from devices of Service S on Service-Specific SSID 810.

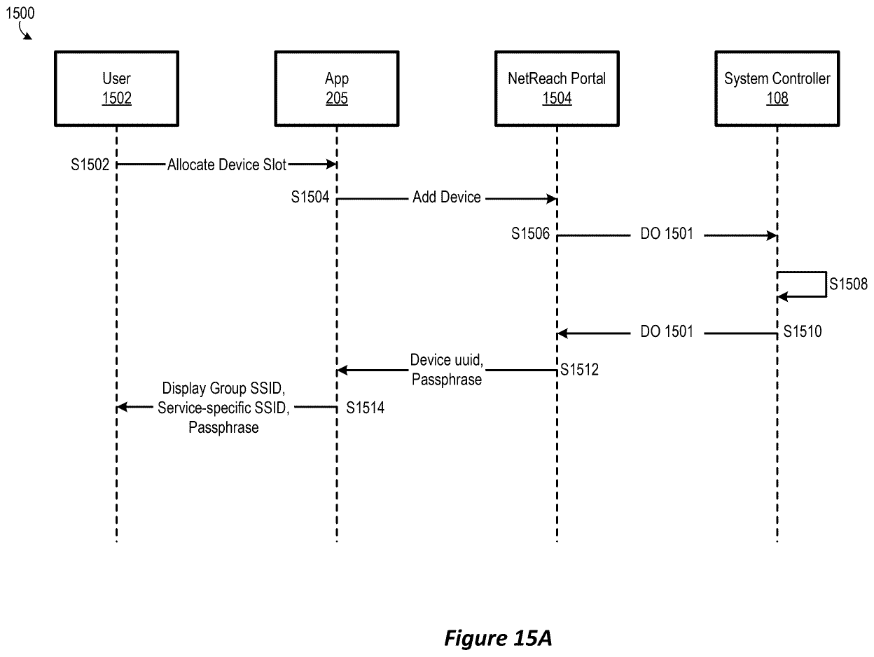

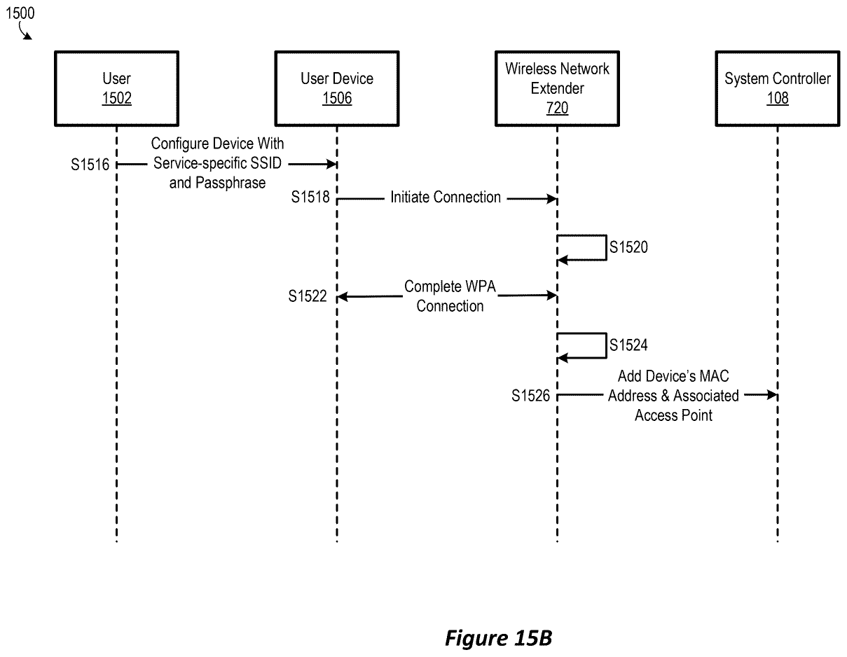

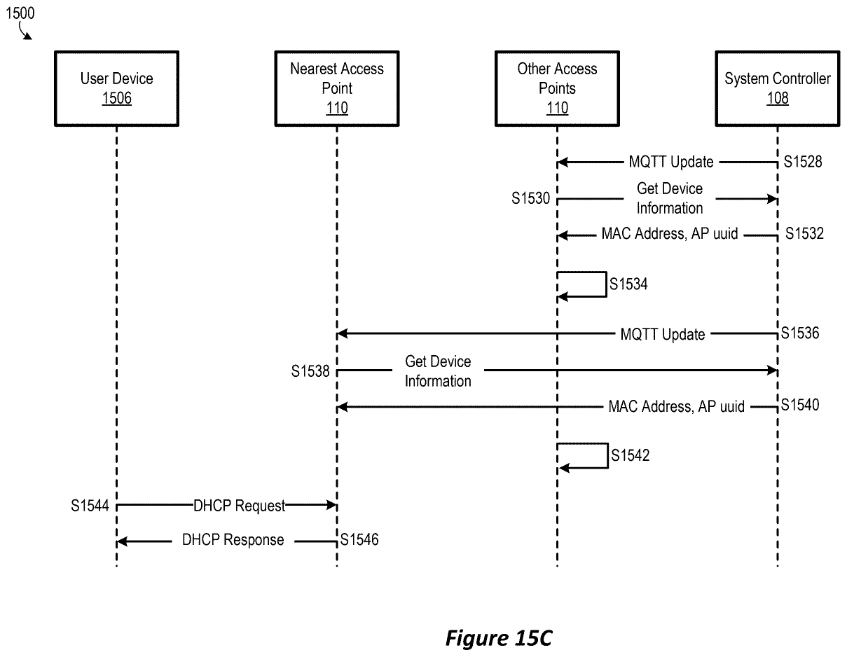

FIGS. 15A-15C are collectively a timing diagram illustrating a method 1500 for onboarding a device onto wireless network extender 720. It is understood though, that a device could be onboarded onto wireless network extender 720 in other manners. FIG. 15A includes dashed lines logically representing each of a user 1502, app 205, a NetReach portal 1504, and system controller 108. FIG. 15B includes dashed lines logically representing each of user 1502, a user device 1506, wireless network extender 720, and system controller 108. FIG. 15C includes dashed lines logically representing each of user device 1506, nearest access point 110, other access points 110, and system controller 108.

In a step S1502 of method 1500, user 1502 engages app 205, e.g., on user device 118 (not shown), to allocate a device slot to new user device 1506. In response thereto, app 205 sends an add device request to NetReach portal 1504 in a step S1504 of method 1500. In a step S1506 of method 1500, NetReach portal 1504 creates a Device Object (DO) 1501 for user device 1506, where Device Object 1501 is associated with service S and includes a name of user device 1506 and a type of user device 1506. In a step S1508 of method 1500, system controller 108 generates a uuid for user device 1506 and a passphrase for user device 1506, and system controller 108 adds aforesaid items to Device Object 1501. System controller 108 also adds an IP address of wireless network extender 720 to Device Object 1501, in step S1508. In a step S1510 of method 1500, system controller 108 returns Device Object DO 1501 to NetReach portal 1504. NetReach portal 1504 provides the uuid for user device 1506 and the passphrase for user device 1506 to app 205 in a step S1512 of method 1500.

In a step S1514 of method 1500, app 205 displays group SSID of access points 110, Service-specific SSID 810 of wireless network extender 720, and a passphrase for user device 1506. At this point, user 1502 could continue onboarding user device 1506 to either an access point 110 or to wireless network extender 720. Method 1500 assumes that user 1502 elects to onboard user device 1506 onto wireless network extender 720, perhaps because wireless network extender 720 has a stronger signal at user 1502's location than any access point 110. Accordingly, in a step S1516 of method 1500, user 1502 configures user device 1506 with Service-specific SSID 810 and the passphrase displayed in step S1514. In a step S1518 of method 1500, user device 1506 initiates a connection to wireless network extender 720. In a step S1520 of method 1500, wireless network extender 720 does not find the passphrase entered into user device 1506 associated with a known MAC address. Therefore, wireless network extender 720 uses NetReach agent 808 to invoke system controller 108's PSK lookup service based on the MAC address of user device 1506 and Service-specific SSID, and wireless network extender 720 matches user device 1506 and Service S. Wireless network extender 720 and user device subsequently complete a WPA connection, e.g., a WPA-2, WPA-3, or higher, connection, in a step S1522 of method 1500.

In a step S1524 of method 1500, wireless network extender 720 sets up an access point bridge to forward traffic between user device 1506 and nearest access point 110. In a step S1526 of method 1500, wireless network extender 720 adds user device 1506's MAC address, as well as nearest access point 110 serving wireless network extender 720, to system controller 108. In a step S1528 of method 1500, system controller 108 sends a MQTT update to other access points 110, and other access points 110 respond in a step S1530 by sending a Get Device Information to system controller 108. System controller 108 responds to the Get Device Information request by sending the MAC address of user device 1506 and the uuid of nearest access point 110 to each other access point 110, in a step S1532 of method 1500. In a step S1534 of method 1500, each other access point 110 (a) sets up a DHCP entry for user device 1506, (b) sets up routing and a tunnel for layer 2 (L2) traffic associated with user device 1506 to nearest access point 110, and (c) sets up micronet access control lists (ACLs) for user device 1506.

In a step S1536 of method 1500, system controller 108 sends a MQTT update to nearest access point 110, and nearest access point 110 responds in a step S1538 by sending a Get Device Information to system controller 108. System controller 108 responds to the Get Device Information request by sending the MAC address of user device 1506 and the uuid of nearest access point 110 to nearest access point 110, in a step S1540 of method 1500. In a step S1542 of method 1500, nearest access point 110 (a) sets up a DHCP entry to user device 1506, (b) routes L2 traffic to user device 1506, (c) sets up routing and a tunnel for layer 2 (L2) traffic associated with other devices in service S, and (d) sets up micronet access control lists (ACLs) for user device 1506. In a step S1544 of method 1500, user device 1506 sends a DHCP request to nearest access point 110, and nearest access point 110 responds with an IP address for user device 1506 in a step S1546 of method 1500. Nearest access point 110 optionally also sends user device 1506 information (G) on gateway 104 as well as a maximum transmission unit (MTU) for the NetReach system, in step S1546. User device 1506 now has full layer 3 connectivity via wireless network extender 720 and nearest access point 110.

All uplink data from user device 1506 received by nearest access point 110 from wireless extender 720 is processed as if user device 1506 were directly connected to nearest access point 110. Any downlink data for user device 1506 is sent to nearest wireless access point 110 and then forwarded by nearest wireless access point 110 to wireless network extender 720. Wireless network extender 720, in turn, forwards the downlink data to user device 1506.

In some embodiments, user device 1506 may present a different MAC address when connecting to wireless network extender 720 than when directly connecting to an access point 110. Accordingly, certain embodiments of the NetReach systems disclosed herein are configured to continue tracking user device 1506 even as its MAC address changes.

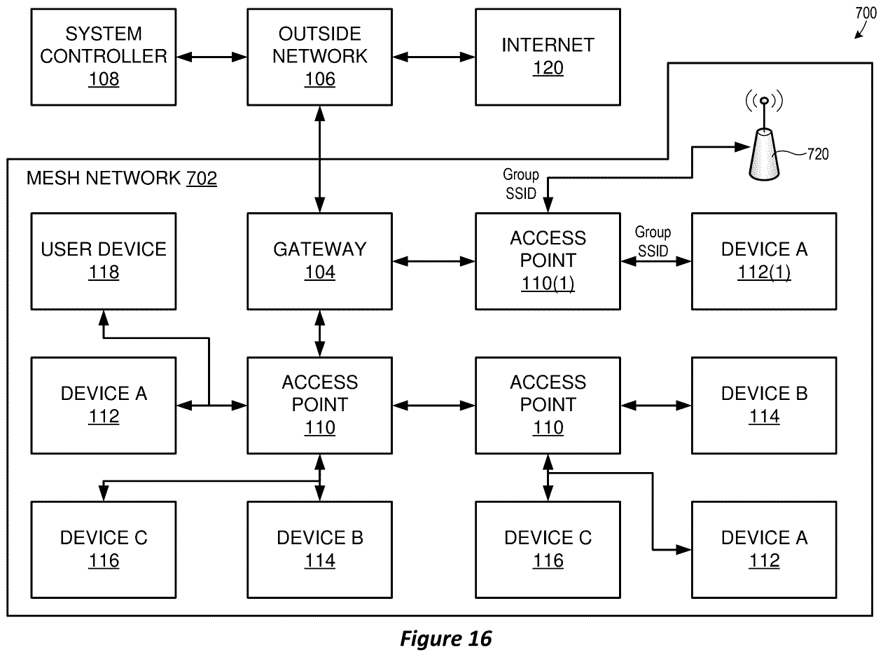

It should be appreciated that access points 110 do not provide a dedicated SSID for supporting wireless network extender 720. Instead, wireless network extender 720 uses the same SSID of an access point 110 as any other device, e.g., devices that are not access points. For example, FIG. 16 illustrates an example of NetReach architecture 700 of FIG. 7 after wireless network extender 720 has been onboarded onto the NetReach system. In this example, wireless network extender 720 is connected to access point 110(1), where access point 110(1) is one instance of access points 110. Additionally, device A 112(1) is also connected to access point 110(1), where device A 112(1) is one instance of a device A 112. Each of wireless network extender 720 and device A 112(1) uses the same SSID, e.g., a group SSID of access points 110, to connect to access point 110(1). As such, wireless network extender 720 does not have a dedicated backhaul connection. However, access point 110(1) learns during onboarding of wireless network extender 720 that wireless network extender 720 is a network extender instead of a conventional device that does not act as an access point. As such, access point 110(1) treats wireless network extender 720 differently than device A 112(1). For example, access point 110(1) may be configured to treat data from wireless network extender 720 as data from multiple devices instead of data from a single device, in view of the fact that wireless network extender may serve multiple wireless network clients. As another example, wireless access point 110(1) may be configured to apply a network extender policy to data associated with wireless network extender 720 while applying a different policy to data associated with a device that is not a wireless network extender.

### Dynamic Activation and Deactivation

Certain embodiments of the NetReach Systems disclosed herein are configured to support dynamic activation and deactivation of communication service for a user. For example, some embodiments enable a user to establish service in minutes, without requiring a technician visit or for the user to obtain customer premises equipment (CPE). Additionally, certain embodiments enable a user to suspend and resume communication service at will. Furthermore, particular embodiments enable a user to deactivate service at will without requiring a technician visit or collection of CPE. As such, these embodiments may make it practical to serve markets with short term and/or transitory communication service needs, which would be impractical to serve using traditional service subscription models.

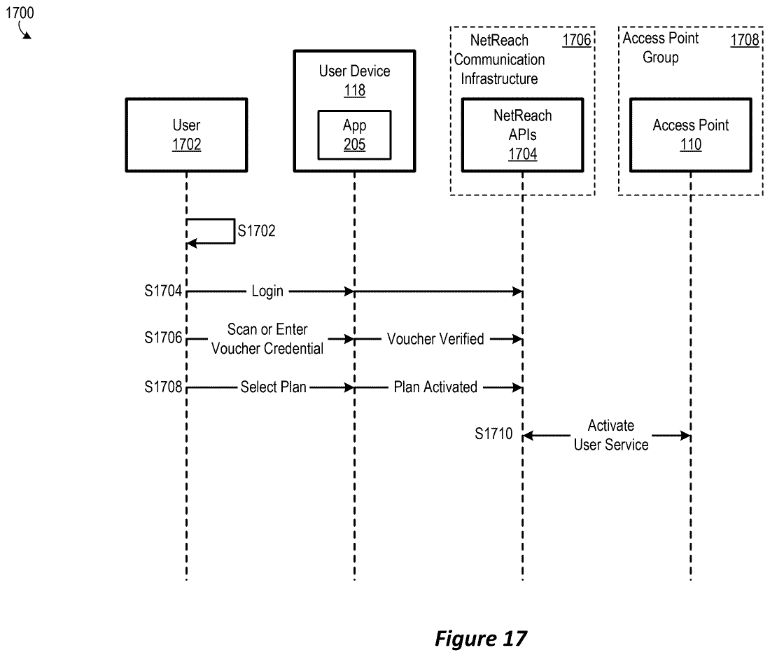

FIG. 17 is a timing diagram illustrating a method 1700 for user plan activation, which is implemented by certain embodiments of the NetReach systems disclosed herein. Particular embodiments of method 1700 may be used to activate a user plan in minutes, without requiring a technician visit or for the user to obtain CPE. FIG. 17 includes dashed lines logically representing each of a user 1702, app 205 on user device 118, NetReach APIs 1704 of NetReach infrastructure 1706, and an access point 110 of a NetReach access point group 1708.

In a step S1702 of method 1700, user 1702 purchases a voucher for communication service, where the voucher includes a voucher credential. In some embodiments, the voucher is a tangible item, such as a paper card with a voucher credential covered by a scratch-off security layer. In some other embodiments, the voucher is an intangible item, such as a digital voucher stored on, or accessible from, user device 118. In either case, the voucher credential uniquely identifies the voucher, and in some embodiments, the voucher credential represents a monetary value of the voucher, a temporal duration of the voucher, a tier of communication service associated with the voucher, etc., In a step S1704, user 1702 logs into their NetReach account via app 205 on user device 118 and NetReach APIs 1704. In a step S1706, user 1702 scans or enters the voucher credential into app 205, and app 205 cooperates with NetReach APIs 1704 of NetReach communication infrastructure 1706 to verify the voucher credential. In a step S1708 of method 1700, user 1702 provides app 205 a selected communication service plan commensurate with the voucher credential. For example, user 1702 may select a service plan based on number of devices that the user wishes to connect, how long the user wishes receive communication service, desired communication service bandwidth, etc. Additionally, in step S1708, app 205 cooperates with NetReach APIs 1704 of NetReach communication infrastructure 1706 to activate the selected plan, after app 205 receives the service plan selection. In a step S1710, NetReach APIs 1704 and access points 110 cooperatively activate communication service for user 1702 in accordance with the selected plan.

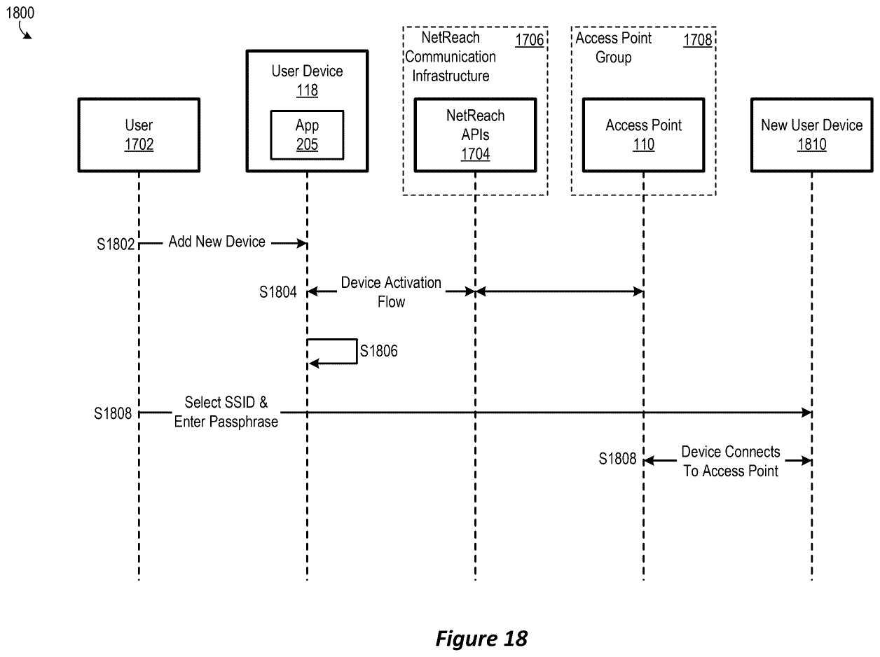

FIG. 18 is a timing diagram illustrating a method 1800 for adding a new user device, which is implemented by certain embodiments of the NetReach systems disclosed herein. FIG. 18 includes a dashed line logically representing a new user device 1810 as well as the dashed lines of FIG. 17. In a step S1802 of FIG. 18, app 205 receives a request from user 1702 to add new user device. In a step S1804 of method 1800, app 205 cooperates with NetReach APIs 1704 and access points 110 to execute a device action flow to add a new user device. In a step S1806, app 205 presents (a) one or more SSIDs representing a network for serving the new user device and (b) a passphrase for the new user device. The one or more SSIDs include, for example, a group SSID of access points 110 and/or a Service-specific SSID of a wireless network extender, e.g., wireless network extender 1720 of FIG. 17. The passphrase for the new user device is unique to the new user device. In a step S1808 of method 1800, the user selects on new user device 1810 a SSID presented in step S1806, and the user enters the password presented in step S1806 on new user device 1810. In a step S1808 of method 1800, new user device 1802 connects to an access point 110, e.g., using a WPA handshake process.

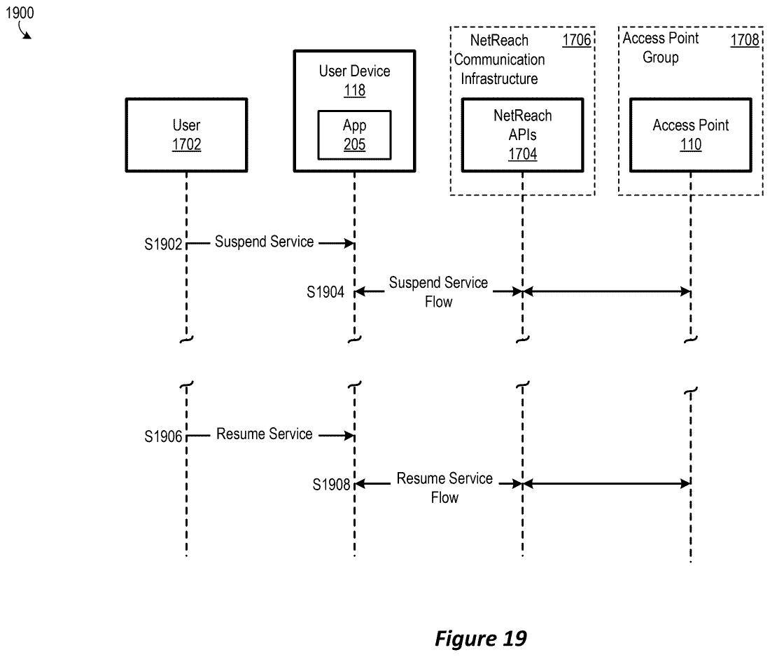

FIG. 19 is a timing diagram illustrating a method 1900 for suspending communication service and subsequently resuming communication service, which is implemented by certain embodiments of the NetReach systems disclosed herein. FIG. 19 includes the same dashed lines as FIG. 17. In a step S1902 of method 1900, app 205 receives a request from user 1720 to suspend communication service. User 1702 may wish to suspend service, for example, if the user will be traveling for a significant amount of time and will therefore not need the communication service. In a block S1904 of method 1900, app 205 cooperates with NetReach APIs 1704 and access points 110 to execute a suspend service flow to suspend communication service for user 1702. Although user 1702's communication service is suspended, user 1702's profile is still present in the NetReach system executing method 1900, which enables user's 1702 communication service to be quickly resumed. In a step S1906 of method 1900, app 205 receives a request from user 1702 to resume communication service. User 1702 resumes communication service, for example, days, weeks, or even months after suspending communication service in step S1902. In a step S1908 of method 1900, app 205 cooperates with NetReach APIs 1704 and access points 110 to execute a resume service flow to resume communication service for user 1702.

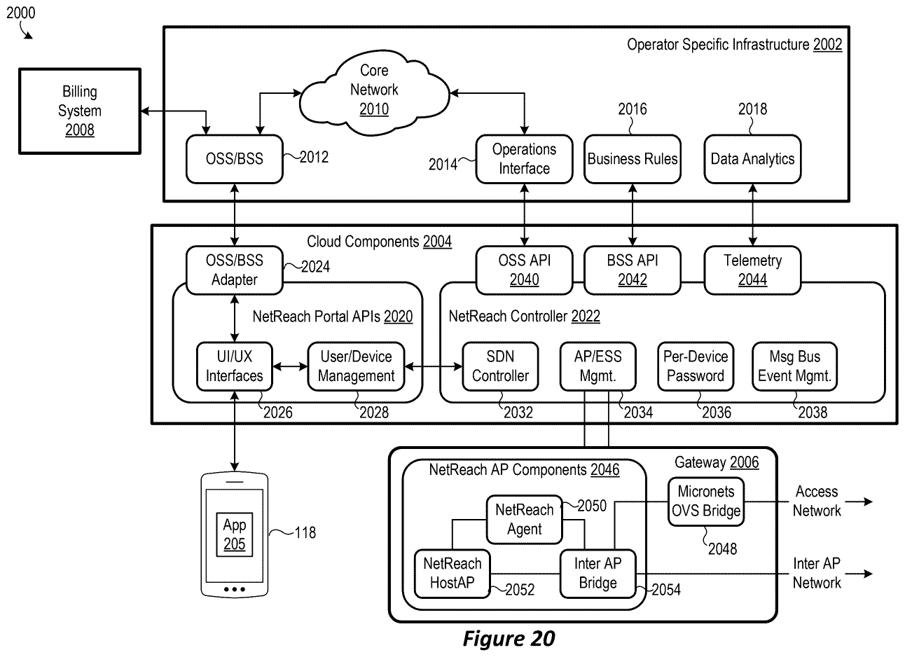

FIG. 20 is a block diagram of a NetReach architecture 2000 configured to leverage existing OSS and business support systems (BSS) of a communication service provider. NetReach architecture 2000 includes operator specific infrastructure 2002, cloud components 2004, a gateway 2006, and user device 118. Operator specific infrastructure 2002 includes a core network 2010, OSS/BSS 2012, an operations interface 2014, business rules 2016, and data analytics 2018. Cloud components 2004 include NetReach portal APIs 2020 and a NetReach controller 2022. NetReach portal APIs 2020 include an OSS/BSS adapter 2024, user interface/user experience (UI/UX) interfaces 2026, and a user/device management module 2028. NetReach controller 2022 includes a SDN controller 2032, an access point (AP)/ESS management module 2034, a per-device password module 2036, a messaging bus event management module 2038, an OSS API 2040, a BSS API 2042, and a telemetry module 2044. Gateway 2006 includes NetReach AP components 2046 and a micronets OVS bridge 2048. Netreach AP components 2046 include a NetReach agent 2050, a NetReach hostAP 2052, and an Inter AP bridge 2054. User device 118 is depicted as a mobile phone in FIG. 20, although it is understood that user device 118 could take other forms without departing from the scope hereof. FIG. 20 depicts App 205 on mobile phone 118.

NetReach portal APIs 1704 and NetReach controller 2022 are communicatively coupled to operator specific infrastructure 2002. As such, the NetReach system of FIG. 20 is advantageously capable of leveraging operator specific infrastructure 2002, as well billing system 2008, such as to facilitate dynamic activation and deactivation of communication service for a user.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., policies, usage categories, device settings, connectivity categories, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

Furthermore, the embodiments described herein improve upon existing technologies, and improve the functionality of computers, by more reliably protecting the integrity and efficiency of computer networks and the devices on those networks at the server-side, and by further enabling the easier and more efficient identification of devices and network traffic at the server-side and the client-side. The present embodiments therefore improve the speed, efficiency, and reliability in which such determinations and processor analyses may be performed. Due to these improvements, the aspects described herein address computer-related issues that significantly improve the efficiency of transmitting messages in comparison with conventional techniques. Thus, the aspects herein may be seen to also address computer-related issues such as dynamic network settings for different devices on network between electronic computing devices or systems, for example.

Exemplary embodiments of systems and methods for category based network device and traffic identification and routing are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for supporting wireless devices in a wireless mesh network, the method comprising:
at a first access point, supporting a first wireless client device using a first service set identifier (SSID); and
at the first access point, supporting a wireless network extender using the first SSID.

2. The method of claim 1, further comprising, at the first access point, treating data associated with the first wireless client device differently from data associated with the wireless network extender.

3. The method of claim 1, further comprising, at the first access point, treating data associated with the wireless network extender at least partially based on information obtained during onboarding of the wireless network extender to the wireless mesh network.

4. The method of claim 3, wherein the wireless network extender is configured to relay data between a second wireless client device and the access point.

5. The method of claim 1, wherein the first wireless client device is selected from the group consisting of a mobile phone, a computer, a personal digital assistant (PDA), and an Internet of Things (IoT) device.

6. The method of claim 1, further comprising, at the wireless network extender, supporting a second wireless client device using a second SSID that is different from the first SSID.

7. The method of claim 1, wherein the wireless network extender comprises a Wi-Fi extender.

8. A method for onboarding a wireless network extender in a wireless mesh network, the method comprising:
transferring each of a first passphrase and a first service set identifier (SSID) to the wireless network extender;
adding the first passphrase to a list of allowed passphrases at a first access point of the wireless mesh network; and
at the first access point, accepting a connection from the wireless network extender on a wireless network identified by a second SSID.

9. The method of claim 8, wherein transferring each of the first passphrase and the first SSID to the wireless network extender comprises transferring the first passphrase and the first SSID to the wireless network extender directly via the first access point.

10. The method of claim 8, wherein transferring each of the first passphrase and the first SSID to the wireless network extender comprises transferring the first passphrase and the first SSID to the wireless network extender via a user device connected to an access point of the wireless mesh network.

11. The method of claim 8, further comprising, before adding the first passphrase to the list of allowed passphrases at the first access point, receiving an extender Device Object at the first access point, the extender Device object including the first SSID and the first passphrase.

12. The method of claim 8, further comprising performing a lookup of the first passphrase.

13. The method of claim 8, further comprising, at the first access point, providing an Internet Protocol (IP) address to the wireless network extender.

14. The method of claim 8, further comprising providing a universally unique identifier (uuid) to the wireless network extender, the uuid representing a first Service associated with the wireless network extender.

15. The method of claim 14, further comprising providing to the wireless network extender respective passphrases and media access control (MAC) addresses of devices of the first Service.

16. The method of claim 8, wherein the wireless network extender comprises a Wi-Fi extender.
